(19) United States
(12) Patent Application Publication
(10) Pub. No.: US 2013/0103593 A1
(43) Pub. Date: Apr. 25, 2013

(54) SYSTEMS, COMPUTER IMPLEMENTED METHODS, AND COMPUTER READABLE MEDIUM HAVING COMPUTER PROGRAM TO GENERATE A COLLECTIVE HERD WARRANTY

(71) Applicants: Tim J. Watts, Billings, MT (US); Steven A. Loar, Billings, MT (US); Craig R. Landgren, Billings, MT (US); Richard Allen, Billings, MT (US); Myles Watts, Bozeman, MT (US)

(72) Inventors: Tim J. Watts, Billings, MT (US); Steven A. Loar, Billings, MT (US); Craig R. Landgren, Billings, MT (US); Richard Allen, Billings, MT (US); Myles Watts, Bozeman, MT (US)

(73) Assignee: UNITED STATES LIVESTOCK PRODUCERS, LLC, Billings, MT (US)

(21) Appl. No.: 13/612,235

(22) Filed: Sep. 12, 2012

Related U.S. Application Data
(60) Provisional application No. 61/549,707, filed on Oct. 20, 2011.

(51) Int. Cl. G06Q 50/00

(52) U.S. Cl. 705/302

(57) ABSTRACT

Systems, computer readable medium having computer program, and related computer implemented methods are provided to aggregate a plurality of customized livestock warranty products so that each of the plurality of customized livestock warranty products is provided to different owners of different herds of a plurality of herds and so that a collective livestock risk product is produced for collective risk management. Embodiments of the present invention advantageously incentivize disease event disclosure by facilitating the purchase of individual warranty products by livestock producers that cover the full value of the producers' losses, yet also incentivize producers to enforce rigorous bio-security measures. Beneficially, the individual warranty products can be provided as part of a collective product for collective reinsurance and collective management of federal indemnity for catastrophic disease events.

### RELATED APPLICATIONS

The present application relates to, claims benefit of, and claims priority to U.S. Provisional Patent Application Ser. No. 61/549,707, titled “Systems, Computer Implemented Methods, and Computer Readable Program Products to Generate a Collective Herd Warranty” and which is incorporated herein by reference in its entirety.

### BACKGROUND OF THE INVENTION

1. Field of the Invention

Embodiments of the present invention relate generally to the field of warranty product aggregation. More specifically, embodiments of the present aggregate a plurality of customized livestock warranty products, each of which are provided to one or more owners of one or more herds of livestock, so that a collective livestock warranty is produced.

2. Description of Related Art

Conventional systems for warranty product management for farm and ranch operations exhibit several disadvantages. There are several risks, for example, that producers (i.e., farmers and ranchers) cannot efficiently or effectively protect against, especially using currently available systems, computer implemented methods, and computer program products. The risk associated with a catastrophic animal disease, for example, is one such risk that current systems fail to protect against. In addition to the loss of diseased animals, the time that a herd spends “laying out” and the time that barns are held open because of quarantine can destroy profitability. Producers may be compensated by the United States government in certain cases of loss, but the compensation may be untimely, insufficient, inadequate for certain types of loss, and costly or difficult to pursue. Although producers may insure against certain types of loss, insurance may be unavailable or prohibitively expensive for all but the most sophisticated producers (e.g., due to economies of scale, economies of scope, or information symmetry). That is, conventional systems and methods of indemnifying and insuring herds against catastrophic risks are expensive, ineffective, unreliable, and do little to bolster the financial security of farm and ranch operations—an industry often plagued by needless financial difficulties.

In addition, conventional systems, computer implemented methods, and computer readable program products provide no incentive for producers to disclose catastrophic events. This failure to disclose imposes negative externalities on other producers, which results in higher systematic costs for the industry. Generally speaking, the risks associated with most livestock diseases can be managed by vaccination or treatment. A small number of particularly virulent or infectious diseases, however, are not amenable to treatment or control, and these are particularly perilous. Although these diseases must be reported to either state or federal authorities in most instances, disclosure is nevertheless disincentivized because many state and federal authorities require a quarantine action or issue a hold order following the reporting of the disease, which greatly impacts the producer's operations and finances. Accordingly, some producers may chose not to disclose a disease instance to avoid such negative consequences. Such inadequate disclosure of a livestock disease by one producer imposes a negative externality on all other farm and ranch operators as the unreported disease may not be addressed in a manner that adequately limits the spread of the disease.

In an effort to encourage producers to disclose disease instances and therefore promote disease control and limitations on the spread of livestock and crop diseases, the United States government has empowered the Animal and Plant Health Inspection Service (APHIS), a division of the United States Department of Agriculture (USDA), to put into place systems to provide federal indemnity (i.e., compensation) to producers for livestock destroyed due to catastrophic disease instances. Although the availability of indemnity from APHIS systems may incentivize some producers to disclose crop and livestock disease instances, the indemnity actually disincentives bio-security measures among producers, such as prevention, detection, containment, and eradication, because the compensation ultimately reduces losses realized by producers.

In turn, inadequate bio-security measures among producers, such as prevention, detection, containment, and eradication, may promote the cultivation and spread of diseases. As a result, for example, diseases may go undetected for some time and may become difficult or costly to eradicate. An undetected disease emerging in the herd of one producer, for example, may spread to the entire herd or may spread to other herds of other producers. Thus, conventional systems, computer implemented methods, and computer readable program products configured to provide liability protection for producers, including the APHIS's systems that facilitate payment of indemnities to farmers and ranchers that have suffered a catastrophic loss, are largely ineffective at reducing the ultimate spread of infectious diseases among livestock and crops. Simply put, such conventional systems, computer implemented methods, and computer readable program products to reduce the risk of catastrophic events often encountered by farmers and ranchers fail to address both the issues of reporting and bio-security in tandem, and are therefore largely ineffective.

Furthermore, reimbursements and indemnities for destroyed animals provided under traditional systems, computer implemented methods, and computer readable program products ultimately may be insufficient, inadequate, or costly to pursue for farm and ranch operations. For example, as noted above, government indemnities actually provide a disincentive to producers to enhance bio-security. This is especially true if the indemnity covers the entire portion of the producer's loss. Presumably recognizing this problem, the APHIS does not provide sufficient indemnity to make the producers whole. Indeed, federal indemnity for destroyed animals will always be insufficient to cover a producer's loss. Federal indemnity, therefore, is not intended to provide income subsidies to producers or to reverse harm done to producers because too-high of compensation will impermissibly disincentivize producers to enforce adequate bio-security measures. Furthermore, receiving compensation is usually untimely, due to the numerous points of bureaucratic inefficiency involved. For example, in order to receive a government indemnity the producer must go through an appraisal process, show proof of destruction, identify the animals destroyed, and wait for the APHIS to process the claim. In short, the government indemnities provided according to traditional systems, methods, and computer readable program products are insufficient in amount and near impossible to rely on.

Insurance products generated according to currently available systems, computer implemented methods, and computer readable program products also fail to adequately protect producers from catastrophic loss. Principally, such conventional insurance products are expensive and difficult to obtain for all but the largest producers. That is, only the largest producers have the economies of scale necessary to make insurance covering the entire herd a value-add option. Thus, under conventional systems and methods of catastrophic event risk reduction, producers are often left to “bet the farm” as they are saddled with an uninsurable risk that could ultimately put such producers out of business. In sum, prior to embodiments of the present invention, no single system, computer implemented method, or computer readable program product was available to producers to adequately address risk to herds and crops due to disease and other catastrophic events in a cost-effective manner while simultaneously incentivizing producers to report disease states and events and bolster bio-security mechanisms and procedures.

### SUMMARY OF THE INVENTION

The Applicant recognizes that early detection, early disclosure, and early containment of livestock diseases are critical to success in reducing the spread of livestock, poultry, crop, and other farm and ranch diseases and have the potential to lead to the eradication of some catastrophic diseases. In addition, the Applicant recognizes the negative externalities imposed by producers failing to adequately report diseases and to adequately enforce bio-security measures. The Applicant also recognizes that federal indemnity creates inverse incentives between reporting and bio-security and accordingly fails to facilitate both enhanced reporting and heightened bio-security. The Applicant, therefore, provides embodiments of the invention that incentivize disclosure by allowing producers to purchase individual warranty products that cover the full value of the producers' losses, yet also incentivize producers to enforce rigorous bio-security measures. The individual warranty products advantageously avoid the attendant inefficiencies, inadequacies, and risks described above because they are produced as part of a collective product for collective reinsurance and collective management of federal indemnity for catastrophic disease events and other risks.

Exemplary embodiments of the present invention, therefore, provide incentives for disclosure, enhance detection and eradication efforts, and assist in providing timely indemnity payments to producers. Embodiments of the present invention are directly applicable in incentivizing early disclosure of reportable diseases and work in harmony with APHIS, thereby supporting the USDA's stated and congressionally mandated goals. Although embodiments directed to animal herds, such as beef, dairy, poultry, swine, sheep, and equine, are most fully described herein, the invention will be understood by those having skill in the art as applicable to crop disease warranty coverage and risk prevention as well. Because the cattle industry is the most segmented sector of the livestock industry, it is, therefore, the most illustrative example of how embodiments of the present invention provide customized warranty products to producers. Embodiments of the invention advantageously promote the domestic farming and ranching trade, thereby increasing agricultural income and providing cost reductions to producers as well as to taxpayers.

Generally, exemplary embodiments of the present invention include a unique warranty product that helps protect livestock producers from financial harm associated with certain livestock diseases. Under this product, producers benefit from timely identification of business losses associated with specific catastrophic diseases and the industry and taxpayers benefit from enhanced detection, improved disclosure, and improved control of certain diseases in the United States in addition to promoting international trade and increasing export premiums captured by the United States livestock industry. As discussed above, the risks associated with most livestock diseases can be managed by vaccination or treatment; however, a small number of particularly virulent or infectious diseases that are not amenable to treatment or control are particularly perilous for herds, and therefore, their producers. These diseases are generally reportable to either state or federal agencies. If the agency requires a quarantine action or issues a hold order following the reporting of the disease, production, institutional, and financial risks may simultaneously impact the producer. Embodiments of the present invention, for example, provide a single resource to producers to address these risks collectively. Some exemplary embodiments of the present invention cover financial exposures and risks associated with the following particularly virulent diseases: (1) Foot and Mouth Disease (“FMD”); (2) Bovine Spongiform Encephalopathy (“BSE”); (3) Bovine Tuberculosis (“TB”); (4) Bovine Brucellosis; and (5) Anthrax.

Embodiments of the present invention, for example, advantageously allow users, such as the owner of livestock or employees or agents thereof, to readily explore the costs of warranty protection for preselected diseases that may affect a herd. Because embodiments of the invention provide customizable warranty products, users can select a cost level and benefit level appropriate for their needs prior to purchasing the warranty product. In addition, users are able to study a plurality of certification schemes, and select one of the certification schemes to be applicable in their warranty, prior to purchasing the warranty product. These unique features and benefits of exemplary embodiments of the present invention help reduce the cost of risk coverage for producers. And, because exemplary embodiments of the present invention require producers to agree to follow certain safety and security guidelines, users of the warranty services under exemplary embodiments of the present invention are incentivized to enhance bio-security and health-safety measures for their herds covered by such warranty services.

Embodiments of the present invention provide warranty products covering the following areas: (1) animal mortality; (2) revenue loss and associated expenses (loss of revenue, clean up, and disposal costs); and (3) liability resulting from traceback actions.

Animal Mortality Coverage

Certain embodiments of the present invention provide warranty products to protect against death, destruction, or depopulation of one or more enrolled animals of a herd under a destruction order or identified by an appropriate authority as resulting from the presence of any of the specified diseases among animals in a herd. Embodiments of the present invention provide payment in a manner that assures owners that, in the case of a catastrophic specified disease affecting their covered herd, there is an assured amount that will be paid and that the payment will be timely. Beneficially, under embodiments of the present invention, for example, the warranty payment amounts and indemnities are known with certainty before the disease event, and therefore there are no negotiations of value after the verified mortality event resulting from a specified disease. This beneficially saves producers expense of negotiating the indemnity coverage, increases the speed at which producers receive payment, provides financial certainty, makes the producers whole, and encourages producers to report disease and mortality events to the benefit of the entire farming and ranching community as well as to the benefit of the end consumer and individual taxpayer.

Revenue Loss and Additional Expense Coverage

Embodiments of the present invention, for example, also provide warranty products to protect against revenue loss and additional expenses associated with maintaining enrolled animals during a quarantine period, provided that such quarantine action or hold order was declared as a result of a confirmed positive disease event test. Embodiments of the present invention provide warranty products to protect against major financial impacts affecting producers when a catastrophic disease strikes, including the loss of business revenue, the cost of cleanup and disposal, and additional costs such as feed costs. In beef cattle, for example, the cost most frequently incurred is added feed expense in part because normal grazing patterns and rotation among patterns are interrupted, and often a cow or calf or stocker operation incurs substantially more than normal feed costs.

Traceback Liability Coverage

In addition, exemplary embodiments of the present invention provide warranty products to protect against traceback liability. Generally speaking, traceability is a key to greater penetration of export markets because many import buyers around the world mandate traceability as a requirement for import criteria of agricultural products, such as, for example, beef products. Therefore, traceback liability is mandated, for example, in many export markets. Traceback liability includes claims brought by an appropriate authority, a similar government authority charged with food safety regulatory activities, by a buyer of beef cattle, or other person, to identify the source(s) of beef cattle sold into commerce that includes enrolled animals identified by a registered program-compliant identifier. Many producers, however, indicate that they would like to not “gamble the value of the ranch” by exposure to traceback liability risks. Accordingly, exemplary embodiments of the present invention provide warranty products to offset potential liability from traceback of livestock and other agricultural products initiated by the public or subsequent owners of such products. Such warranty products, for example, can be linked to certain standards within a user-selected USDA Process Verified Program (“PVP”).

Applicants recognize that early detection, disclosure, and containment of livestock diseases are critical to success in reducing the spread of livestock disease and have the potential to lead to the eradication of some catastrophic diseases. Applicants also recognize that early containment is also essential to furthering the goals of USDA, promoting herd health in the U.S., and furthering U.S. trade objectives. Embodiments of the present invention provide incentives for such early detection and disclosure in a manner fostering early containment plans. That is, exemplary embodiments of the present invention provide strong incentives for individual producers, through disclosure, to minimize damage to the United States economy as a result of a disease outbreak. Embodiments of the present invention, for example, provide assured compensation through a warranty approach that uses existing management and reporting standards. In addition to the above described benefits, exemplary embodiments of the present invention provide the following important economic benefits.

First, exemplary embodiments of the present invention beneficially will reduce short-term government budget exposure to depopulation expense. More specifically, exemplary embodiments of the present invention will facilitate more intense management and surveillance in disease-troubled areas, along with a livestock insurance safety net for producers, which will allow APHIS to utilize all the tools in its arsenal to address disease outbreaks quickly. Depending on the type of coverage selected by a user, producer participation and reliance on business interruption protection will support longer term approaches to disease eradication by APHIS.

Second, exemplary embodiments of the present invention will enhance economic protection for producers. Such exemplary embodiments of the present invention will immediately help to reduce the size of “economic sanctions” on livestock producers of a covered disease outbreak by reducing the size of the impacted area, reducing the length of the surveillance through proactive measures, and providing for incentives for producers to adopt progressive measures to assist surveillance in surrounding regions.

Third, exemplary embodiments of the present invention beneficially will provide incentives for early disease detection. By providing incentives for early detection and early disclosure in conjunction with early containment of outbreaks, embodiments of the present invention can substantially reduce taxpayer exposure to expense associated with disease outbreak. This can stem, for example, from a reduction and potential eradication of targeted diseases such as Bovine Tuberculosis and Bovine Brucellosis and a substantial decline in expenditures for Avian Influenza and other targeted diseases.

Fourth, in addition to reducing the federal budget exposure to costs related to targeted diseases, embodiments of the present invention can further enhance producer revenue. Embodiments of the present invention provide incentives for participation in animal ID tracking systems, and make possible more effective management and surveillance in disease-troubled areas. As a result, embodiments of the present invention can facilitate expansion of export markets in the livestock arena.

Embodiments of the present invention can provide, for example, a livestock warranty aggregation system to mitigate the above concerns for producers by providing customized warranties (“warranty products”) to producers and aggregating such warranty products for collective management. Collective management advantageously allows for centralized control by a holder, which beneficially (i) allows the holder of the risk product to negotiate enhanced terms for reinsurance; (ii) increases the efficiency in which the holder of the risk product can secure reimbursement (e.g., from the government) in the event of a loss; (iii) decreases costs in managing risks associated with a loss; (iv) provides for more timely payments for the value of livestock that are affected by a destruction order issued by an appropriate animal health official; (v) provides for more timely payments to producers to compensate for the time lost due to facilities being held out of production or prevented from operation and normal sales of livestock; and (vi) protects warranty aggregation participants with liability protection for producers in the event of traceback liability. In addition, a secondary advantage of centralized control includes enhanced disclosure of risk factors and loss data by producers, according to the terms of the warranty product, which results in better control of disease and, in turn, lower cost to taxpayers for government compensation.

Beneficially, exemplary embodiments of the present invention can bridge the gap between government indemnity payments, such as those from APHIS, and traditional livestock insurance. For example, consider a producer who desires to insure his/her livestock against financial loss due to catastrophic disease events. As explained above, traditional insurance products are often too expensive to obtain and government indemnities are often insufficient to cover the full cost of loss to the producer due to disease events. Exemplary embodiments of the present invention can satisfy the need of such a producer by providing a customized warranty product at an affordable rate to cover more fully the cost of loss of livestock to the producer due to catastrophic disease events.

For example, embodiments of the present invention can provide a warranty issuing entity, or agent, that serves as a face to producers interested in purchasing one or more warranty products for their livestock or herds. The warranty issuing entity can communicate, over a communications network, with interested livestock producers, a risk retention group, and the government. Beneficially, one or more livestock producers can purchase an individual warranty product from the warranty issuing entity. The warranty issuing entity can then aggregate the one or more individual warranty products purchased by the one or more livestock producers into a collective warranty product. The warranty issuing entity can then purchase or otherwise obtain liability insurance for the collective warranty product from the risk retention group. Accordingly, payments for the aggregate, collective warranty can be made by the warranty issuing entity to the risk retention group. The risk retention group can, according to various exemplary embodiments of the present invention, limit its liability by seeking reinsurance or underwriting from a reinsurance provider or underwriter under a reinsurance contract.

In the event of a catastrophic disease event that affects a livestock producer holding a warranty product from the warranty issuing entity, that livestock producer can communicate the loss to the warranty issuing entity. The warranty issuing entity can then communicate that producer's loss to the risk retention group, to receive payment under the aggregate collective warranty product, and the government, to receive payment under government-established indemnities for destroyed livestock. Often, however, disease events may affect more than one livestock producer. Beneficially, the warranty issuing entity can receive a plurality of notices of loss from a plurality of livestock producers. The warranty issuing entity then can aggregate the plurality of losses into an aggregate loss and communicate such aggregate loss to the risk retention group. The risk retention group can then issue payment for such aggregate loss to the warranty issuing entity according to the terms of the aggregate, collective warranty product held by the warranty issuing entity and provided by the risk retention group. Based on the aggregate, collective warranty product, the risk retention group can issue payments for aggregate loss to the warranty issuing entity and such payments can be received by the warranty issuing entity. In addition, the warranty issuing entity can beneficially have a working understanding with the government regarding government-provided indemnities for destroyed livestock. Accordingly, the warranty issuing entity can communicate such aggregate loss to the government and receive indemnity payments from the government for destroyed livestock. The warranty issuing entity can then separate the aggregate warranty product payments received from the risk retention group and the aggregate indemnity payments received by the government into amounts associated with each individual warranty product.

Beneficially, the warranty issuing entity can provide, according to various exemplary embodiments of the present invention, advance payments for government-provided indemnities associated with each of the one or more livestock producers' respective loss. Such advance indemnity payments beneficially allow the one or more livestock producers to receive such indemnities in a timely fashion and allows the one or more livestock producers to continue operations without having to wait for government-provided indemnities. The warranty issuing entity can issue one or more individual warranty product payments to one or more livestock producers according to the terms of each of the one or more livestock producers' individual warranty products. The warranty issuing entity can provide payments for any government-provided indemnities associated with each of the one or more livestock producers' respective loss.

According to various exemplary embodiments of the present invention, the risk retention group can seek reinsurance for amounts paid to the warranty issuing entity from the reinsurance provider or underwriter. Moreover, according to various exemplary embodiments of the present invention, the warranty issuing entity can be one or more warranty issuing entities, the risk retention group can be one or more risk retention groups, and the reinsurance provider or underwriter can be one or more reinsurance providers or underwriters. Furthermore, the relationships described above can be implemented using one or more computers or servers according to various exemplary embodiments of the present invention.

By way of example, an embodiment of the present invention can include a warranty aggregation system. The warranty aggregation system can comprise, for example, a plurality of producer computers, each producer computer of the plurality of producer computers being connected to a warranty communications network and having one or more user interface devices to receive from a livestock producer a plurality of customized warranty parameters for a respective herd of a plurality of different herds, each producer computer of the plurality of producer computers further having an input/output unit to output the plurality of customized warranty parameters through the warranty communications network so that a warranty product for the respective herd of the plurality of different herds is generated responsive thereto. The warranty aggregation system also can comprise a warranty rate database, having stored therein a warranty rate table and a livestock warranty aggregation computer positioned in communication with the plurality of producer computers through the warranty communications network, the livestock warranty aggregation computer being adapted to receive through the warranty communications network the plurality of customized warranty parameters for each herd of the plurality of different herds, the livestock warranty aggregation computer having a processor to generate a warranty product for each herd of the plurality of different herds responsive to the plurality of customized warranty parameters for the respective herd of the plurality of different herds and the warranty rate table, thereby defining a plurality of warranty products. The processor can, for example, be further configured to aggregate the plurality of warranty products to thereby define a collective product.

Beneficially, the warranty aggregation system can also include a livestock insurance computer to allow collective management of aggregate risk for the plurality of different warranty products, the livestock insurance computer positioned in communication with the livestock warranty aggregation computer by a reinsurance communications network, the livestock insurance computer having an input/output unit to receive from the livestock warranty aggregation computer the collective product and to send to the livestock warranty aggregation computer payment information responsive to casualty data for the aggregate risk of the plurality of different warranty products. In addition, and according to exemplary embodiments of the present invention, the livestock warranty aggregation computer can include a livestock reimbursement computer to allow individual management of risk for each of the plurality of different warranty products, the livestock reimbursement computer positioned in communication with the livestock warranty aggregation computer by a reimbursement communications network, the livestock reimbursement computer having an input/output unit to receive from the livestock warranty aggregation computer one or more of the plurality of warranty products and to send to the livestock warranty aggregation computer payment information responsive to individual casualty data for one or more of the plurality of warranty products.

In addition, the warranty aggregation system can be, for example, adapted to generate a user interface to display at each of the plurality of producer computers, the user interface allowing the selection of the customized warranty parameters at the respective user terminal and the transmission of the customized warranty parameters from the respective producer computer to the livestock warranty aggregation computer. Moreover, the warranty aggregation system according to various exemplary embodiments of the present invention can also be adapted to distribute payments to a livestock producer account responsive to receiving insurance payments and reimbursement payments for a respective herd.

Yet another exemplary embodiment of the present invention can include, for example, non-transitory computer storage medium having computer program stored therein such as in memory of a livestock warranty aggregation computer. The livestock warranty aggregation computer 100 can be configured, for example, to aggregate a plurality of customized livestock warranty products so that each of the plurality of customized livestock warranty products is provided to different owners of different herds of a plurality of herds and so that a collective livestock risk product is produced for collective risk management. Beneficially, the livestock warranty aggregation computer can comprise, for example, a processor, a non-transitory memory positioned in communication with the processor to store a computer readable program product therein, and an input/output unit connected to the processor and the non-transitory memory. The input/output unit, for example can be adapted to be in communication with a plurality of producer computers through a warranty communications network to receive one or more warranty parameters from each of the plurality of producer computers, each producer computer of the plurality of producer computers corresponding to a different owner of a different herd of the plurality of herds. The livestock warranty aggregation computer can also include, by way of example, a warranty rate database to associate the warranty parameters with a plurality of warranty rates and a computer program product defining a livestock warranty aggregator, stored in the non-transitory memory and operable by the processor.

The livestock warranty aggregator can, for example, have a set of instructions that, when executed by the processor, cause the livestock warranty aggregation computer to perform one or more operations. The one or more operations beneficially can include, for example, the operation of generating a warranty selection interface to display at the plurality of producer computers the warranty selection interface allowing a livestock producer at a respective producer computer of the plurality of producer computers to select a plurality of customized warranty parameters for a respective herd of the plurality of herds and to transmit from the respective producer computer the plurality of customized warranty parameters to the livestock warranty aggregation computer, the plurality of customized warranty parameters including each of a loss type, a livestock type, a quantity of livestock for the livestock type, and a livestock payout value for the livestock type. The one or more operations can also include the operation of determining a herd warranty purchase price for each herd of the plurality of herds responsive to receiving the plurality of customized warranty parameters from the respective producer computer, the herd warranty purchase price being responsive to a respective warranty rate for the livestock type and the plurality of customized warranty parameters for the respective herd, and the operation of generating a warranty proposal for each herd of the plurality of herds responsive to determining the herd warranty purchase price for the respective herd, and the warranty proposal including the herd warranty purchase price for the respective herd and the plurality of customized warranty parameters for the respective herd.

Moreover, according to various exemplary embodiments of the present invention, the one or more operations also can include the operation of generating a warranty confirmation interface to display at the plurality of producer computers for each respective herd responsive to the warranty proposal for the respective herd, the warranty confirmation interface allowing the livestock producer at the respective producer computer to confirm the herd warranty purchase price and the customized warranty parameters for the respective herd and to transmit to the livestock warranty aggregation computer a warranty purchase confirmation for the warranty proposal for the respective herd. In addition, the one or more operations can include the operation of generating a warranty product for each herd of the plurality of herds responsive to receiving the warranty purchase confirmation for the respective herd, the warranty product including the herd warranty purchase price for the respective herd and the customized warranty parameters for the respective herd, each warranty product having a warranty payout value corresponding to the livestock payout value for the respective herd, thereby defining a plurality of warranty products, each of the plurality of warranty products being different for each respective herd.

Furthermore, according to various embodiments of the present invention, the one or more operations can include the operations of aggregating a collective livestock risk product from the plurality of warranty products, the collective livestock risk product having an aggregate liability value responsive to the livestock payout value for each of the plurality of warranty products, outputting the collective livestock risk product to a livestock insurance computer to allow enhanced risk management for the plurality of warranty products responsive to the aggregate liability value of the collective livestock risk product, and outputting one or more of the plurality of warranty products, thereby defining a plurality of claim products, to a livestock disease reimbursement computer responsive to receiving casualty data for respective herds of each of the plurality of claim products, thereby allowing enhanced compensation for each of the respective different herds.

Advantageously, various embodiments of the present invention can provide one or more individualized warranty products to one or more producers of livestock. Various embodiments of the present invention can also provide one or more individualized warranty products to one or more producers of agricultural crops. With specific respect to beef cattle, various embodiments of the present invention can provide warranty protection to producers against potential financial exposure due to the following specified diseases for beef cattle, as such diseases are known and understood by those skilled in the art: (1) Foot and Mouth Disease; (2) Bovine Spongiform Encephalopathy (BSE); (3) Bovine Tuberculosis; (4) Bovine Brucellosis; and (5) Anthrax. Various embodiments of the present invention also can provide warranty protection for various other diseases if it is determined that such diseases are transmitted as a result of natural, sporadic infection, occasional endemic infection, or acts of terrorism, as is known and understood by those skilled in the art. Under various exemplary embodiments of the present invention, other intentional infections or infection that occurs when a livestock producer fails to conform to certain warranty guidelines, are not provided warranty protection.

### BRIEF DESCRIPTION OF THE DRAWINGS

So that the manner in which the features and benefits of the invention, as well as others which will become apparent, may be understood in more detail, a more particular description of the embodiments of the invention may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a schematic block diagram of a system to aggregate a plurality of customized livestock warranty products according to an exemplary embodiment of the present invention.

FIG. 2 is a schematic block diagram of a system to aggregate a plurality of customized livestock warranty products wherein one or more livestock producers can obtain an individualized, customized livestock warranty product upon meeting select quality assurance and bio-security conditions according to an exemplary embodiment of the present invention.

FIG. 3 is a schematic diagram of a graphical user interface facilitating selection and customization of an individualized, customized warranty product by a livestock producer for one or more herds of beef cattle according to an exemplary embodiment of the present invention.

FIG. 4 is a schematic diagram of a graphical user interface facilitating selection and customization of an individualized, customized warranty product by a livestock producer for one or more herds of beef cattle according to an exemplary embodiment of the present invention.

FIG. 5 is a schematic diagram of a graphical user interface facilitating selection and customization of an individualized, customized warranty product by a livestock producer for one or more herds of beef cattle according to an exemplary embodiment of the present invention.

FIG. 6 is a schematic diagram of a graphical user interface facilitating selection and customization of an individualized, customized warranty product by a livestock producer for one or more herds of beef cattle according to an exemplary embodiment of the present invention.

FIG. 7 is a schematic diagram of a graphical user interface facilitating selection and customization of an individualized, customized warranty product by a livestock producer for one or more herds of beef cattle according to an exemplary embodiment of the present invention.

FIG. 8 is a schematic diagram of a graphical user interface facilitating selection and customization of an individualized, customized warranty product by a livestock producer for one or more herds of beef cattle according to an exemplary embodiment of the present invention.

FIG. 9 is a schematic diagram of a graphical user interface facilitating selection and customization of an individualized, customized warranty product by a livestock producer for one or more herds of beef cattle according to an exemplary embodiment of the present invention.

FIG. 10 is a schematic diagram of a graphical user interface facilitating selection and customization of an individualized, customized warranty product by a livestock producer for one or more herds of beef cattle according to an exemplary embodiment of the present invention.

FIG. 11 is a schematic diagram of a graphical user interface facilitating confirmation of an individualized, customized warranty product by a livestock producer for one or more herds of beef cattle according to an exemplary embodiment of the present invention.

FIG. 12 is a schematic diagram of a graphical user interface facilitating purchase of an individualized, customized warranty product by a livestock producer for one or more herds of beef cattle according to an exemplary embodiment of the present invention.

FIG. 13 is a schematic diagram of a graphical user interface facilitating payment for an individualized, customized warranty product by a livestock producer for one or more herds of beef cattle according to an exemplary embodiment of the present invention.

FIG. 14 is a schematic diagram of a graphical user interface facilitating payment for an individualized, customized warranty product by a livestock producer for one or more herds of beef cattle according to an exemplary embodiment of the present invention.

FIG. 15 is a schematic diagram of a graphical user interface facilitating payment for an individualized, customized warranty product by a livestock producer for one or more herds of beef cattle according to an exemplary embodiment of the present invention.

FIG. 16 is a schematic block diagram of a system to aggregate a plurality of customized livestock warranty products according to an exemplary embodiment of the present invention.

FIG. 17 is a schematic block diagram of a system to aggregate a plurality of customized livestock warranty products according to an exemplary embodiment of the present invention.

FIG. 18 is a schematic block diagram of a system to aggregate a plurality of customized livestock warranty products illustrating a plurality of producer computers in communication with a traffic management server via a communications network according to an exemplary embodiment of the present invention.

FIG. 19 is a schematic block diagram of a system to aggregate a plurality of customized livestock warranty products according to an exemplary embodiment of the present invention.

FIG. 20 is a schematic block diagram of a system to aggregate a plurality of customized livestock warranty products according to an exemplary embodiment of the present invention.

FIG. 21 is a schematic block diagram of a system to aggregate a plurality of customized livestock warranty products according to an exemplary embodiment of the present invention.

FIG. 22 is a schematic block diagram of a system to aggregate a plurality of customized livestock warranty products according to an exemplary embodiment of the present invention.

FIG. 23 is a schematic block diagram of a system to aggregate a plurality of customized livestock warranty products according to an exemplary embodiment of the present invention.

FIG. 24 is a schematic block diagram of a system to aggregate a plurality of customized warranty products illustrating a producer computer and a producer mobile device in communication with a livestock warranty aggregation computer according to an exemplary embodiment of the present invention.

FIG. 25 is a schematic block diagram of a system to aggregate a plurality of customized warranty products according to an exemplary embodiment of the present invention.

FIG. 26 is a schematic block operational flow diagram of operational flow of computer readable operations stored on a computer readable medium in memory of a warranty aggregation computer according to an exemplary embodiment of the present invention.

FIG. 27 is a schematic block operational flow diagram of operational flow of a system, computer implemented method, and computer readable program product to aggregate a plurality of customized livestock warranty products.

FIG. 28 is a schematic block diagram of a system to aggregate a plurality of customized warranty products according to an exemplary embodiment of the present invention.

### DETAILED DESCRIPTION

The present invention will now be described more fully hereinafter with reference to the accompanying drawings, which illustrate various embodiments of the invention. This invention, however, may be embodied in many different forms and should not be construed as limited to the embodiments set forth herein. Rather, these embodiments are provided so that this disclosure will be thorough and complete, and will fully convey the scope of the invention to those skilled in the art. It is to be fully recognized that the different teachings of the various embodiments discussed below may be employed separately or in any suitable combination to produce desired results. The various characteristics mentioned above, as well as other features and characteristics described in more detail below, will be readily apparent to those skilled in the art upon reading the following detailed description of the various embodiments, and by referring to the accompanying drawings. In the drawings and description that follow, like parts are marked throughout the specification and drawings with the same reference numerals, respectively. The prime notation, if used, indicates similar elements in alternative embodiments. The drawings are not necessarily to scale. Certain features of the disclosure may be shown exaggerated in scale or in somewhat schematic form and some details of conventional elements may not be shown in the interest of clarity and conciseness.

Exemplary embodiments of the present invention advantageously provide, for example, systems, computer readable program products, and related computer implemented methods to aggregate a plurality of customized livestock warranty products so that each of the plurality of customized livestock warranty products is provided to different owners of different herds of a plurality of herds and so that a collective livestock risk product is produced for collective risk management. As used herein, a herd can be any company of animals, including but not limited to, domestic animals, feeding or traveling together, as the term is known and understood by those skilled in the art. Such animals can include, for example, but are not limited to, cattle and other bovine, sheep, goats, pigs and other swine or porcine, horses and other equine, and chickens and other poultry.

Such systems, computer readable program products, and related computer implemented methods, according to exemplary embodiments of the present invention, advantageously provide livestock warranty aggregation to by providing customized warranties (“warranty products”) to producers and aggregating such warranty products for collective management. Collective management advantageously allows for centralized control by a warranty holder, which beneficially (i) allows the holder of the risk product to negotiate enhanced terms for reinsurance; (ii) increases the efficiency in which the holder of the risk product can secure reimbursement (e.g., from the government) in the event of a loss; (iii) decreases costs in managing all risks associated with a loss; (iv) provides for more timely payments for the value of livestock that are affected by a destruction order issued by an appropriate animal health official; (v) provides for more timely payments to producers to compensate for the time lost due to facilities being held out of production or prevented from operation and normal sales of livestock; and (vi) protects warranty aggregation participants with liability protection for producers in the event of traceback liability. In addition, a secondary advantage of centralized control includes enhanced disclosure of risk factors and loss data by producers, according to the terms of the warranty product, which results in better control of disease and, in turn, lower cost to taxpayers for government compensation.

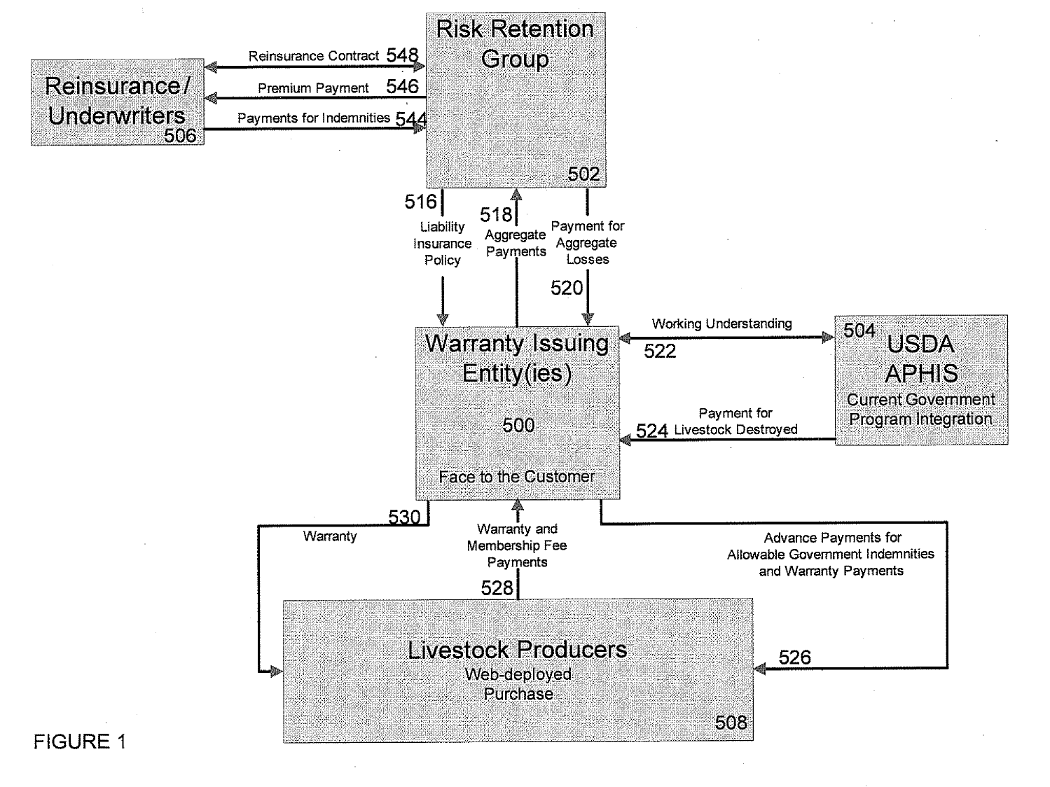

As is perhaps best illustrated by FIG. 1, exemplary embodiments of the present invention can bridge the gap between government indemnity payments, such as those from APHIS 504, and traditional livestock insurance. For example, consider a producer who desires to insure his/her livestock against financial loss due to catastrophic disease events. Traditional insurance products are often too expensive to obtain and government indemnities are often insufficient to cover the full cost of loss to the producer due to disease events. Exemplary embodiments of the present invention can satisfy the need of such a producer by providing a customized warranty product at an affordable rate to cover more fully the cost of loss of livestock to the producer due to catastrophic disease events.

For example, various embodiments of the present invention can provide a warranty issuing entity 500 that serves as a face to producers interested in purchasing one or more warranty products for their livestock or herds 508. The warranty issuing entity 500 can communicate, over a communications network (not illustrated), with interested livestock producers, as is known and understood by those skilled in the art 508, a risk retention group, as is known and understood by those skilled in the art 502, and the government, as is known and understood by those skilled in the art 504. More specifically, the government can be, for example, a branch of the United States government such as the USDA or the APHIS, as such branches of the United States government are known and understood by those skilled in the art. Although such agencies currently manage indemnity payments to livestock producers for destroyed livestock due to catastrophic disease events, embodiments of the present invention are not limited to any one particular government-indemnity entity, branch, or department, and embodiments of the present invention recognize that such government entity, branch, or department may change from time to time.

Beneficially, one or more livestock producers 508 can purchase an individual warranty product 530 from the warranty issuing entity 500. The warranty issuing entity 500 then can aggregate the one or more individual warranty products 530 purchased by the one or more livestock producers 508 into a collective warranty product. The warranty issuing entity 500 then can purchase or otherwise obtain liability insurance 516 for the collective warranty product from the risk retention group 502. Accordingly, payments for the aggregate, collective warranty product 518 can be made by the warranty issuing entity 500 to the risk retention group 502. The risk retention group 502 can, according to various exemplary embodiments of the present invention, limit its liability by seeking reinsurance or underwriting from a reinsurance provider or underwriter 506 under a reinsurance contract 548.

In the event of a catastrophic disease event that affects a livestock producer 508 holding a warranty product 530 from the warranty issuing entity 500, that livestock producer 508 can communicate the loss to the warranty issuing entity 500. The warranty issuing entity 500 then can communicate that producer's 508 loss to the risk retention group 502, to receive payment 520 under the aggregate collective warranty product 516, and the government 504, to receive payment under government-established indemnities for destroyed livestock 524. Often, however, disease events may affect more than one livestock producer 508. Beneficially, the warranty issuing entity 500 can receive a plurality of notices of loss from a plurality of livestock producers 508. The warranty issuing entity 500 then can aggregate the plurality of losses into an aggregate loss and communicate such aggregate loss to the risk retention group 502. The risk retention group 502 then can issue payment for such aggregate losses 520 to the warranty issuing entity 500 according to the terms of the aggregate, collective warranty product 516 held by the warranty issuing entity 500 and provided by the risk retention group 502. Based on the aggregate, collective warranty product 516, the risk retention group 502 can issue payments for aggregate loss 520 to the warranty issuing entity 500 and such payments 520 can be received by the warranty issuing entity 500. In addition, the warranty issuing entity 500 beneficially can have a working understanding 522 with the government 504 regarding government-provided indemnities for destroyed livestock 524. Accordingly, the warranty issuing entity 500 can communicate such aggregate loss to the government 504 and receive indemnity payments 524 from the government 504 for destroyed livestock. The warranty issuing entity 500 then can separate the aggregate warranty product payments 520 received from the risk retention group 502 and the aggregate indemnity payments 524 received by the government 504 into amounts associated with each individual warranty product 530.

The warranty issuing entity 500 can also provide payments for any government-provided indemnities 524 associated with each of the one or more livestock producers' 508 respective loss. Beneficially, the warranty issuing entity 500 also can provide, according to various exemplary embodiments of the present invention, advance payments for government-provided indemnities 524, 526 associated with each of the one or more livestock producers' 508 respective loss. Such advance indemnity payments 526 beneficially allow the one or more livestock producers 508 to receive such indemnities 524 in a timely fashion and allows the one or more livestock producers 508 to continue operations without having to wait for government-provided indemnities 524.

According to various exemplary embodiments of the present invention, the risk retention group 502 can seek reinsurance for amounts paid to the warranty issuing entity 500 from the reinsurance provider or underwriter 506. Moreover, according to various exemplary embodiments of the present invention, the warranty issuing entity 500 can be one or more warranty issuing entities 500, the risk retention group 502 can be one or more risk retention groups 502, and the reinsurance provider or underwriter 506 can be one or more reinsurance providers or underwriters 506.

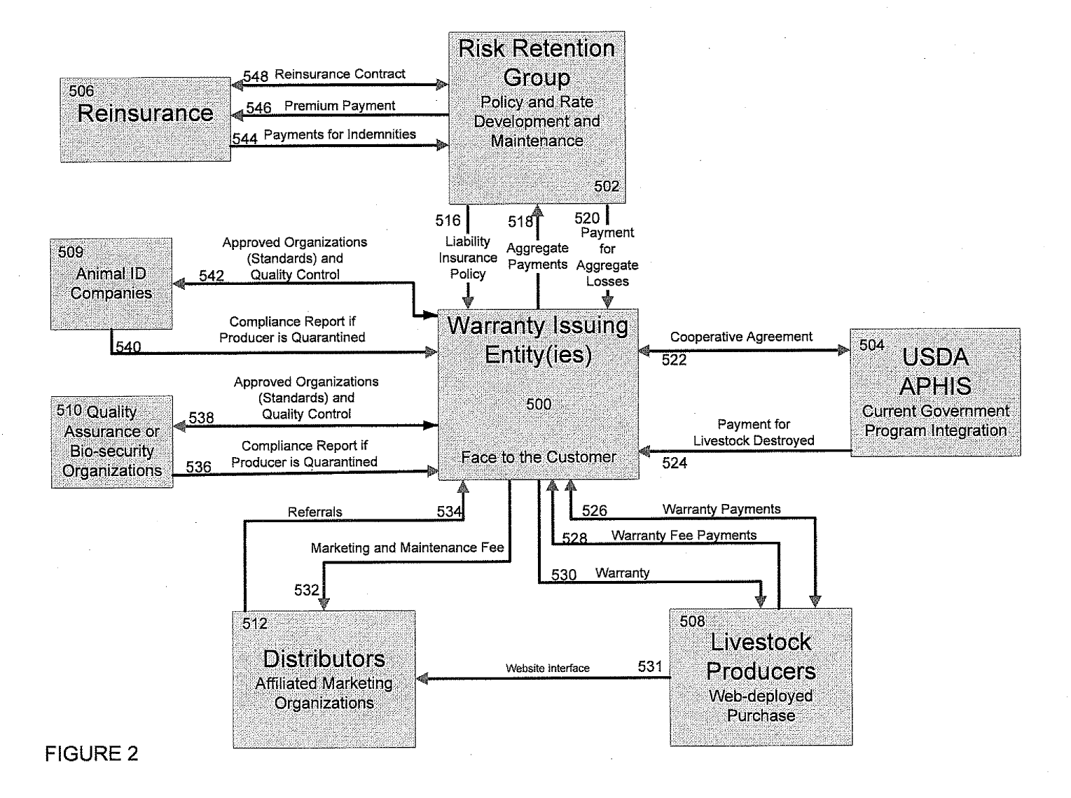

In addition to the various aspects of exemplary embodiments of the present invention as illustrated in FIG. 1, FIG. 2 illustrates the relationship between one or more animal ID companies, as is known and understood by those skilled in the art 509, one or more quality assurance or bio-security organizations, as is known and understood by those skilled in the art 510, and one or more distributors or affiliated marketing organizations, as is known and understood by those skilled in the art 512. More particularly, FIG. 2 illustrates a schematic block diagram of a system, computer readable program products, and related computer implemented methods to aggregate a plurality of customized livestock warranty products 530 wherein one or more livestock producers 508 can obtain an individualized, customized livestock warranty product upon meeting select quality assurance and bio-security conditions according to an exemplary embodiment of the present invention.

According to various exemplary embodiments of the present invention, one or more warranty issuing entities 500 may require one or more livestock producers 508 to meet certain standards for quality control and bio-security prior to purchasing a customized, individual warranty product 530 from the one or more warranty issuing entities 500. These standards for quality control or bio-security beneficially can be provided by one or more animal ID companies 509 or one or more quality assurance or bio-security organizations 510. For example, the one or more animal ID companies 509 can provide approved standards and quality control requirements 542 to the one or more warranty issuing entities. The one or more quality assurance or bio-security organizations also can, for example, provide standards and quality control requirements 538 to the one or more warranty issuing entities. The one or more warranty issuing entities 500 also can request the one or more animal ID companies 509 or the one or more quality assurance or bio-security organizations 510 to verify that the one or more livestock producers 508 are complying with such quality standards and controls 542, 538. Moreover, according to various exemplary embodiments of the present invention, the one or more animal ID companies 509 and the one or more quality assurance or bio-security organizations 510 can provide one or more compliance reports 540, 536 for one or more livestock producers 508 who have quarantined livestock or herds.

FIG. 2 also illustrates, by way of example, the interaction between one or more livestock producers 508 and one or more distributors 512. Distributors 512 can include any affiliated marketing organizations as is known and understood by those skilled in the art. The one or more distributors 512, according to various exemplary embodiments of the present invention, can provide one or more referrals 534 of one or more livestock producers 508 to the one or more warranty issuing entities 500. Responsive to such one or more referrals 534, the one or more warranty issuing entities 500 can provide one or more marketing fees 532 or one or more maintenance fees 532 to the one or more distributors 512. Beneficially, the one or more livestock producers 508 can communicate with the one or more distributors 512 using one or more website interfaces 531.

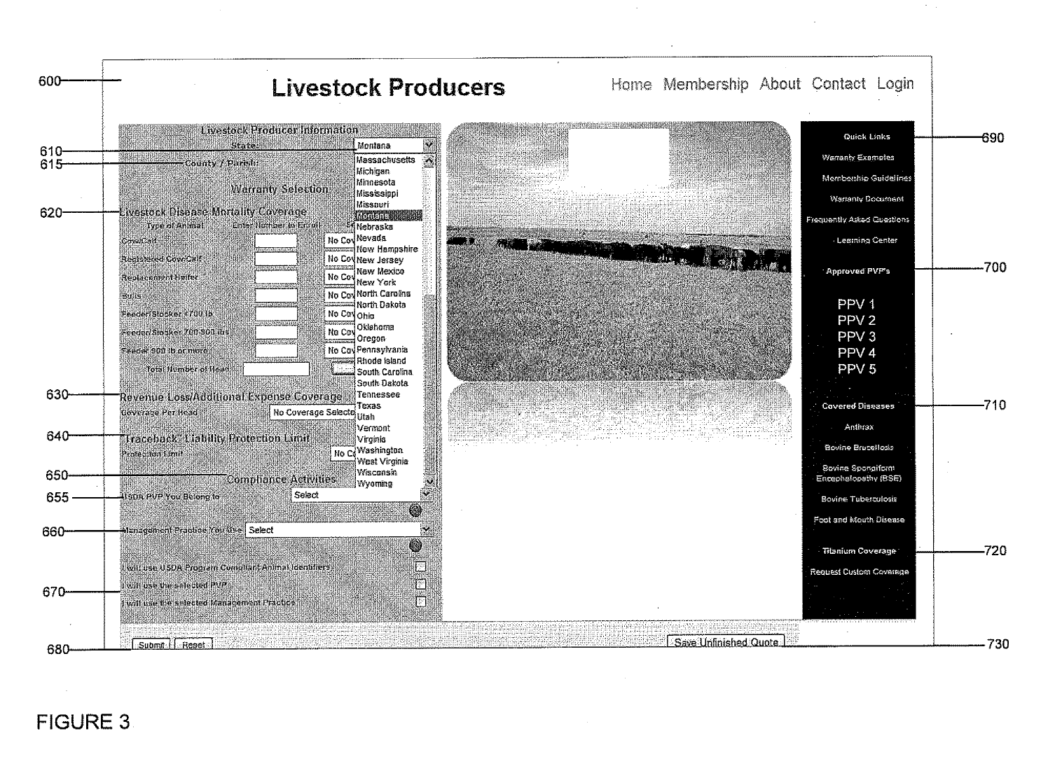

Furthermore, the systems, computer readable program product, and related computer implemented methods to aggregate a plurality of customized livestock warranty products accordingly to exemplary embodiments of the present invention, and as discussed above, can be implemented using one or more computers, one or more servers, one or more databases, and one or more communications networks. The graphical user interface of one such system, according to an exemplary embodiment of the presentation, is perhaps best illustrated by FIGS. 3-15.

FIGS. 3-15 are schematic diagrams of a graphical user interface facilitating selection, customization, confirmation, and purchase of an individualized, customized warranty product by a livestock producer for one or more herds of beef cattle to be aggregated with one or more other individualized, customized warranty products for one or more herds of beef cattle according to an exemplary embodiment of the present invention. FIGS. 3-11, for example, illustrates a graphical user interface 600 that can be displayed on one or more display devices of one or more livestock producer computers according to an exemplary embodiment of the present invention.

The graphical user interface 600 can include, by way of example, a state drop-down selection tool 610 to facilitate selection, by a livestock producer, of the state where the livestock producer's livestock or herd are located, a county or parish drop-down selection tool 615, to facilitate selection, by the livestock producer, of the county or parish were a livestock producer's livestock or herd are located, a livestock disease mortality coverage selection tool 620 to facilitate selection, by the livestock producer, of livestock warranty coverage options for the livestock producer's livestock or herd, a revenue loss and added expense coverage selection tool 630 to facilitate selection, by the livestock producer, of warranty options associated with revenue loss or additional expense coverage, a traceback liability protection limit selection tool 640 to facilitate selection, by the livestock producer, of a protection limit for traceback liability protection, a compliance activities selection tool 650, to facilitate selection, by the livestock producer, of various compliance activities options, including the process verified program (“PVP”) that the livestock producer belongs to 655, the management practice the livestock provider selects to use 660, and whether the livestock producer will use USDA program compliant animal identifiers, whether the livestock producer will use the selected PVP, and whether the livestock producer will use the selected management practice 670. The graphical user interface 600 can also include, for example, user interface navigation buttons 680, such as “SUBMIT” and “RESET” that allow the livestock producer to either submit the selected livestock warranty options or reset the form so that new livestock warranty options can be selected. In addition, the user interface can provide a user interface navigation button, labeled “SAVE UNFINISHED QUOTE” 730 that beneficially can allow a livestock producer to save selected livestock warranty options without submitting the livestock warranty product for further processing so that the work can be returned to at a later time.

The graphical user interface can also provide, according to various exemplary embodiments of the present invention, links 690 to warranty examples, membership guidelines, warranty documents, frequently asked questions, or a learning center. In addition, for example, the graphical user interface can provide a list of approved PPVs 700 and links to each of the approved PPVs. Moreover, the graphical user interface can also provide the livestock producer with links to diseases that are covered under offered warranty products 710 and a link to obtain even greater coverage (labeled, for example, “titanium coverage”) than is provided using the graphical user interface 720. The links described above can be, for example, hyper-text markup language (“HTML”) links or any other kind of linking interface as known and understood by those skilled in the art. Moreover, according to various embodiments of the present invention, the graphical user interface 600 can be an Internet website, accessible by a communications network, and can include a graphical user interface title (not shown), a graphical user interface subtitle (not shown), and one or more graphical user interface input components 610, 615, 620, 630, 640, 650, 655, 660, 670, 680, 690, 700, 710, 720, 730 to receive input from one or more livestock producers who access the graphical user interface via one or more graphical user interface devices on one or more producer computers.

By way of further detailing an exemplary embodiment of the present invention, FIG. 3 shows the state drop-down selection tool 610 expanded after a livestock producer has selected the tool with one or more user input devices, such as a mouse or a keyboard. The keyboard can include, for example, an alphanumeric keyboard, an IBM PC keyboard, an Apple keyboard, a chorded keyboard, a brail keyboard, a numeric keypad, a stenograph, a QWERTY keyboard, and any other electronic keyboard as is known and understood by those skilled in the art. The mouse can include, for example, a mechanical mouse, an optical mouse, a three-dimensional mouse, a gyroscopic mouse, an inertial mouse, a double mouse system, a track ball, a laser mouse, or any other pointing device that detects motion relative to a supporting surface as is known and understood by those skilled in the art. Although some states are hidden from view, FIG. 3 illustrates that the livestock producer can select, via the one or more user input devices using the state drop-down selection tool 610, the state where the livestock producer's livestock or herd is located. Options can include, for example, Massachusetts, Michigan, Minnesota, Mississippi, Missouri, Montana, Nebraska, Nevada, New Hampshire, New Jersey, New Mexico, New York, North Carolina, North Dakota, Ohio, Oklahoma, Oregon, Pennsylvania, Rhode Island, South Carolina, South Dakota, Tennessee, Texas, Utah, Vermont, Virginia, Washington, West Virginia, Wisconsin, Wyoming, and any other state within the fifty states of the United States of America, as is known and understood by those skilled in the art. As illustrated in this FIG. 3, the livestock producer has selected Montana using the one or more user input devices as is indicated by the dark highlighting around the word “Montana.”

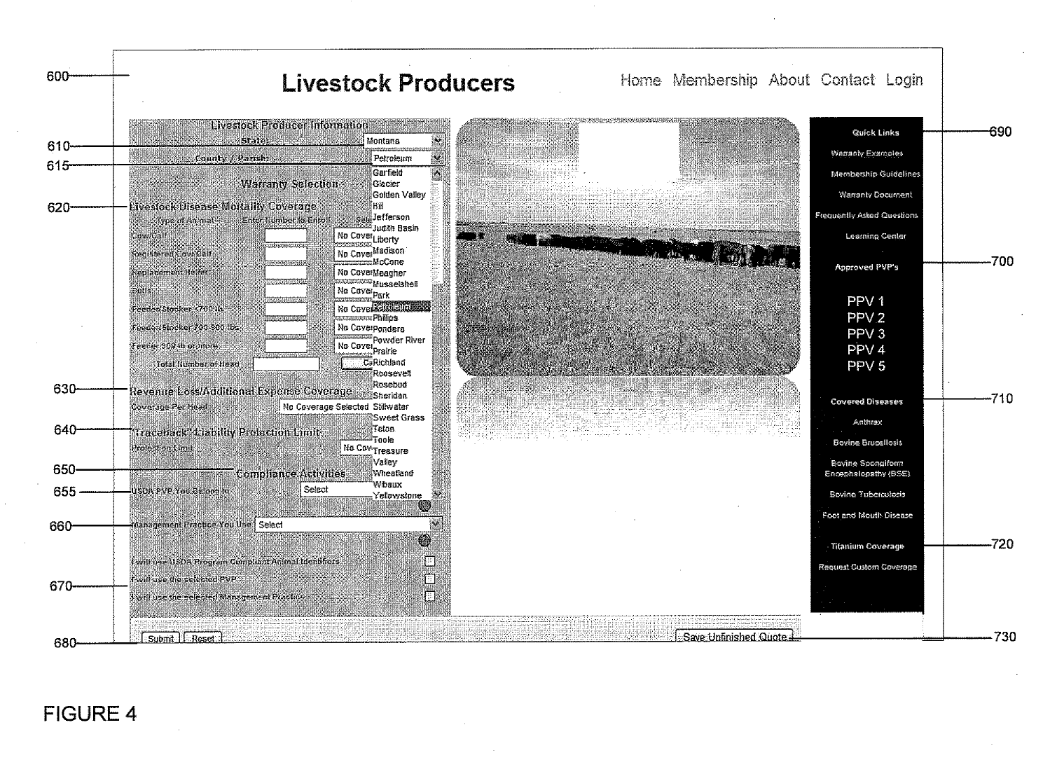

FIG. 4, for example, further illustrates the county or parish drop-down selection tool 615 according to an exemplary embodiment of the present invention. FIG. 3 shows the county or parish drop-down selection tool 615 expanded after a livestock producer has selected the tool with the one or more user input devices. Although some selectable counties and parishes are hidden from view, FIG. 4 illustrates that the livestock producer can select the county or parish where the livestock producer's livestock or herd is located. Selectable county and parish options are responsive to the state selected by the livestock producer. Because, in this example, the livestock producer selected Montana, the county or parish drop-down selection tool 615 provides as selectable counties or parishes those counties or parishes within the state of Montana. In this example, options include, but are not limited to, Garfield, Glacier, Golden Valley, Hill, Jefferson, Judith Basin, Liberty, Madison, McCone, Meagher, Musselshell, Park, Petroleum, Phillips, Pondera, Power River, Prairie, Richland, Roosevelt, Rosebud, Sheridan, Stillwater, Sweet Grass, Teton, Toole, Treasure, Valley, Wheatland, Wibaux, Yellowstone, and any other county or parish of the State of Montana as is known and understood by those skilled in the art.

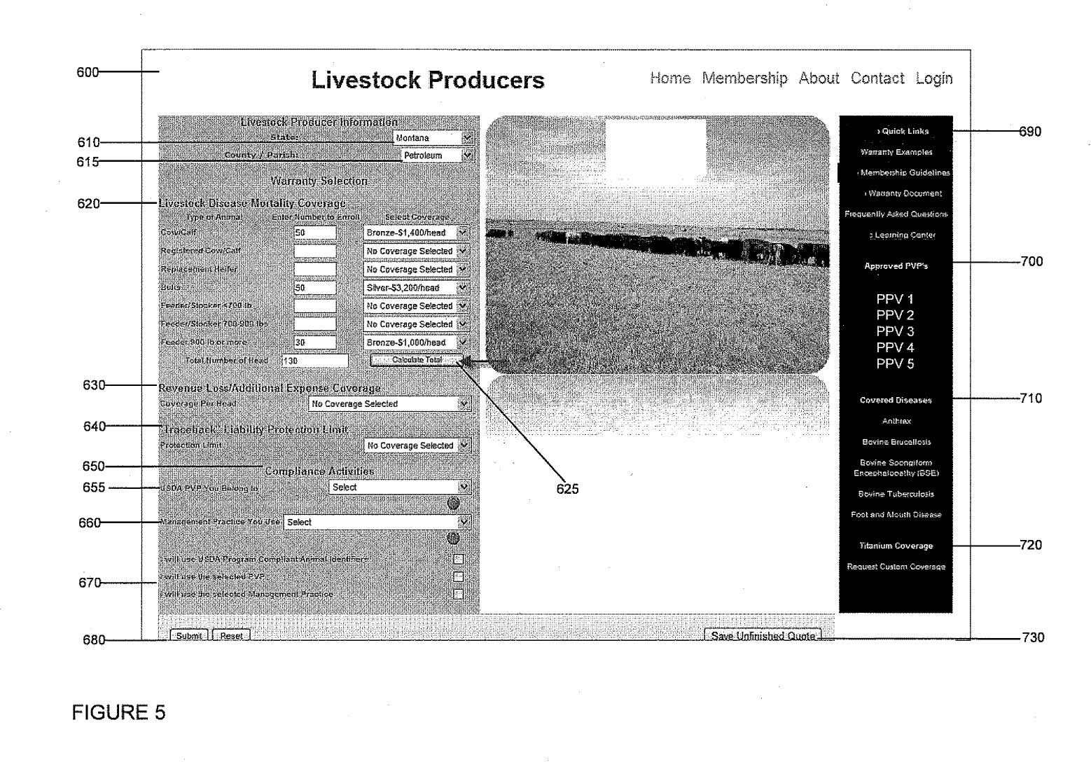

FIG. 5 further illustrates the operable functionality of the above-described livestock disease mortality coverage selection tool 620 that facilitates selection, by the livestock producer, of livestock warranty coverage options for the livestock producer's livestock or herd. For example, under this exemplary embodiment of the present invention, the livestock producer can select livestock warranty coverage based on the number and type of animal that the livestock producer desires to purchase livestock warranty coverage for. For example, as illustrated in FIG. 5, the livestock producer can select from the following types of animals as these types of animals are known and understood by those skilled in the art: (1) cow/calf; (2) registered cow/calf; (3) replacement heifer; (4) bulls; (5) feeder/stocker <700 lb; (6) feeder/stocker 700-900 lbs; and (7) feeder 900 lbs or more. The livestock producer beneficially then can select the number of each type of animal that the livestock producer desires to enroll in the warranty product. Then, the livestock producer can select the type of livestock warranty coverage that the livestock producer desires to purchase for each particular type of animal. Notably, according to various embodiments of the present invention, the livestock producer need not select the same type of coverage for all of the animals enrolled in the livestock warranty product. According to this particular embodiment of the present invention, the livestock producer can select, for example, one of the following types of coverage for each type of animal to be enrolled in the livestock warranty product: (1) No coverage; (2) Basic coverage; (3) Copper coverage; (4)

Bronze coverage; (5) Silver coverage; (6) Gold coverage; and (7) Platinum Coverage. As discussed above, titanium coverage can be requested under this exemplary embodiment of the present invention by contacting the one or more warranty issuing entities 720. Once the livestock producer has selected the desired livestock warranty level for each of the types of animals to be enrolled in the warranty product, the livestock provider can click the “CALCULATE TOTAL” user interface button 625 to calculate the total amount of requested livestock warranty coverage. As illustrated in this FIG. 5, the livestock producer has selected Bronze coverage for 50 cows/calfs at $1,400 per head, Silver coverage for 50 bulls at $3,200 per head, and Bronze coverage for 30 feeders weighing 900 lbs or more at $1,000 per head by providing input via a user interface input device through the livestock disease mortality coverage selection tool 620. Advantageously, the livestock producer can select greater coverage for animals that are more expensive or perhaps more difficult to replace in the event of a disease event.

Advantageously, various exemplary embodiments of the present invention do not require the livestock producer to associate specific USDA program compliant identifiers with the livestock warranty coverage selected or to report inventory changes to the one or more warranty issuing entities. Rather, for example, the responsibility for maintaining records associated with the livestock warranty product provided according to embodiments of the present invention is the purview of the PVP. This beneficially simplifies compliance for the livestock producer. As a result of this simplification, however, if the livestock producer holding a warranty product according to embodiments of the present invention has 900 eligible animals, but purchases warranty coverage products for only 600 animals; this leaves 300 unwarranted animals that need to be addressed. This is accomplished, for example, by a proration of coverage based on the relationship of actual inventory to warranted inventory. According to various exemplary embodiments of the present invention, at least ninety-percent (90%) of the animals in a livestock warranty member's herd, by animal type (or class), that are in proximity to one another at any time during a livestock warranty period must be included under a single warranty. Eligible livestock that never are in proximity to each other during the period of a warranty can be included, for example, under separate warranties. Various exemplary embodiments of the present invention, for example, do not require the livestock producer member to include eligible livestock that are geographically separated from other enrolled animals as long as those animals do not come into contact or intermingle with each other during the livestock warranty period. In the event that a livestock producer member enrolls fewer eligible animals than ninety-percent (90%) of the herd by class, at any site, any livestock warranty product payment will be subject to the inventory in excess of warranty adjustment.

According to various exemplary embodiments of the present invention, the one or more warranty issuing entities can reserve the right to examine the animals enrolled in various warranty products and all pertinent records relating to such animals as often as the one or more warranty issuing entities requires until the end of a select record retention period. The select record retention period, for example, can begin on the effective date of the livestock warranty product coverage and can extend, for example, for three years after the end of such livestock warranty product coverage. Records for enrolled animals existing on the effective date can be, for example, considered to have been created on that date. The one or more warranty issuing entities may require complete records that demonstrate compliance with the requirements or guidelines of the selected approved management program and the selected PVP; and with the acquisition and insertion of program compliant identifiers. By paying the livestock warranty product fees for any livestock warranty period, the livestock producer member can authorize the one or more warranty issuing entities, according to various exemplary embodiments of the present invention, to obtain records relating to the enrolled animals from any person who may have custody of those records, including but not limited to: packers, banks, shippers, sale barns, stockyards, internet businesses, associations, and accountants, as these terms are known and understood by those skilled in the art. According to some exemplary embodiments of the present invention, the livestock producer member must assist the one or more warranty issuing entities to obtain all records that the warranty issuing entities desire to request from third parties. The one or more warranty issuing entities, for example, can maintain confidentiality of producer records and can disclose information received from the livestock producer only as directed by a properly constituted directive from a court or other authority legally authorized, or in the administration of a claim.

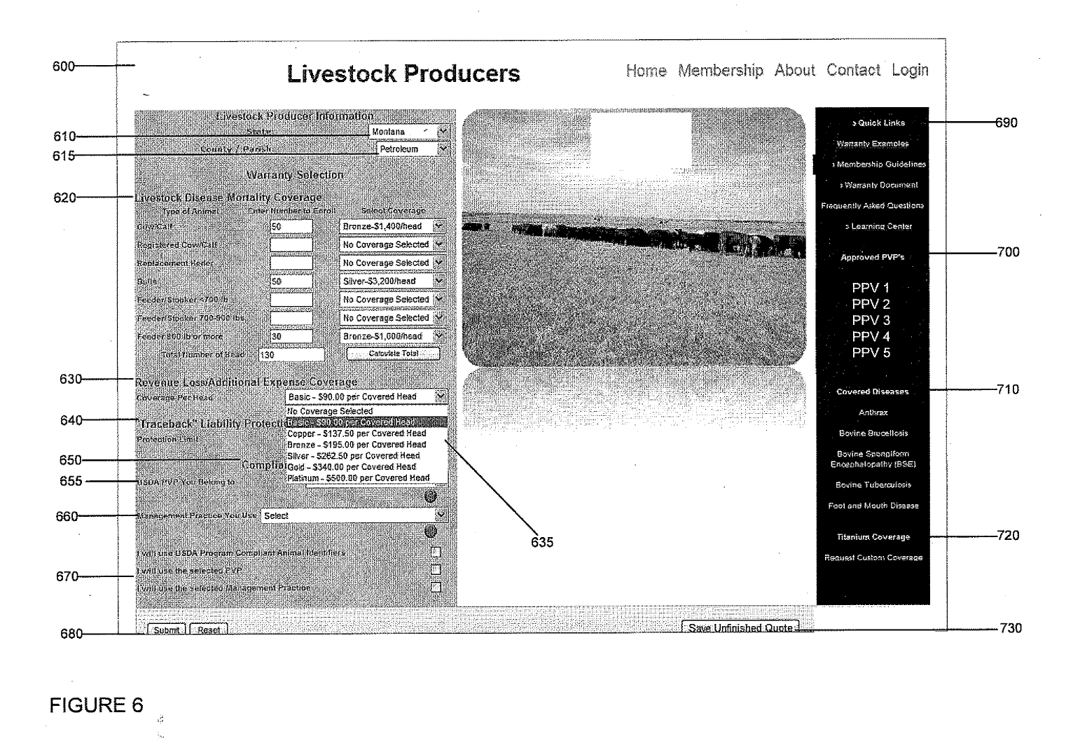

FIG. 6 further illustrates the operable functionality of the above-described livestock disease revenue loss and added expense coverage selection tool 630 that facilitates selection, by the livestock producer, of warranty options associated with revenue loss or additional expense coverage 635. As with the levels of livestock warranty coverage, the livestock producer can select various livestock disease revenue loss and added expense coverage including, by way of example only, Basic coverage, Copper coverage, Bronze coverage, Silver coverage, Gold coverage, and Platinum coverage. Each level of livestock warranty coverage can be, for example, associated with a different price 635. For example, under various embodiments of the present invention, Platinum coverage is more expensive than Gold coverage, which is more expensive than Silver coverage. As illustrated in this FIG. 6, the livestock producer selected Basic coverage at $90 per covered head 635 by providing input through a user interface input device using the revenue loss and added expense coverage selection tool 630.

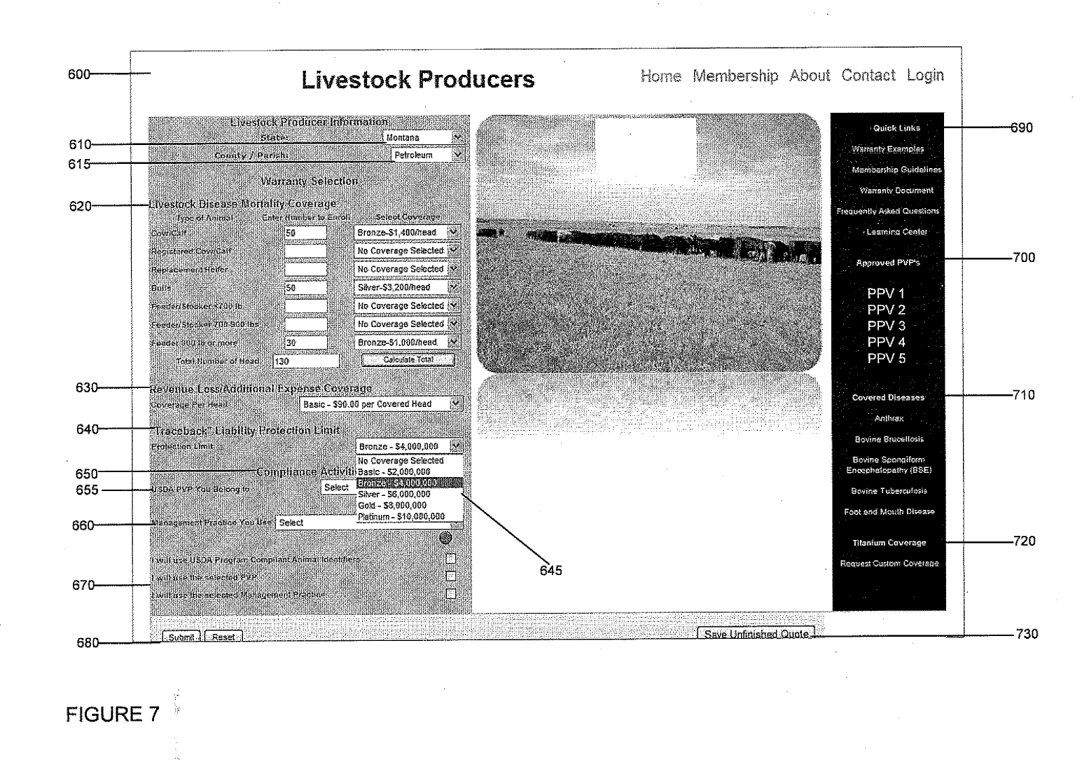

FIG. 7 further illustrates the operable functionality of the above-described traceback liability protection limit selection tool 640 that facilitates selection, by the livestock producer, of a protection limit for traceback liability protection 645. As with the levels of livestock warranty coverage and revenue loss and additional expense coverage, the livestock producer can select various livestock traceback liability protection limits including, by way of example only, Basic coverage, Bronze coverage, Silver coverage, Gold coverage, and Platinum coverage. Each level of traceback liability protection limit coverage can be, for example, associated with a different price 645. For example, under various embodiments of the present invention, Platinum coverage is more expensive than Gold coverage, which is more expensive than Silver coverage. As illustrated in this FIG. 7, the livestock producer selected Bronze coverage at $4,000,000 total 645 by providing input through a user interface input device using the traceback liability protection limit selection tool 640.

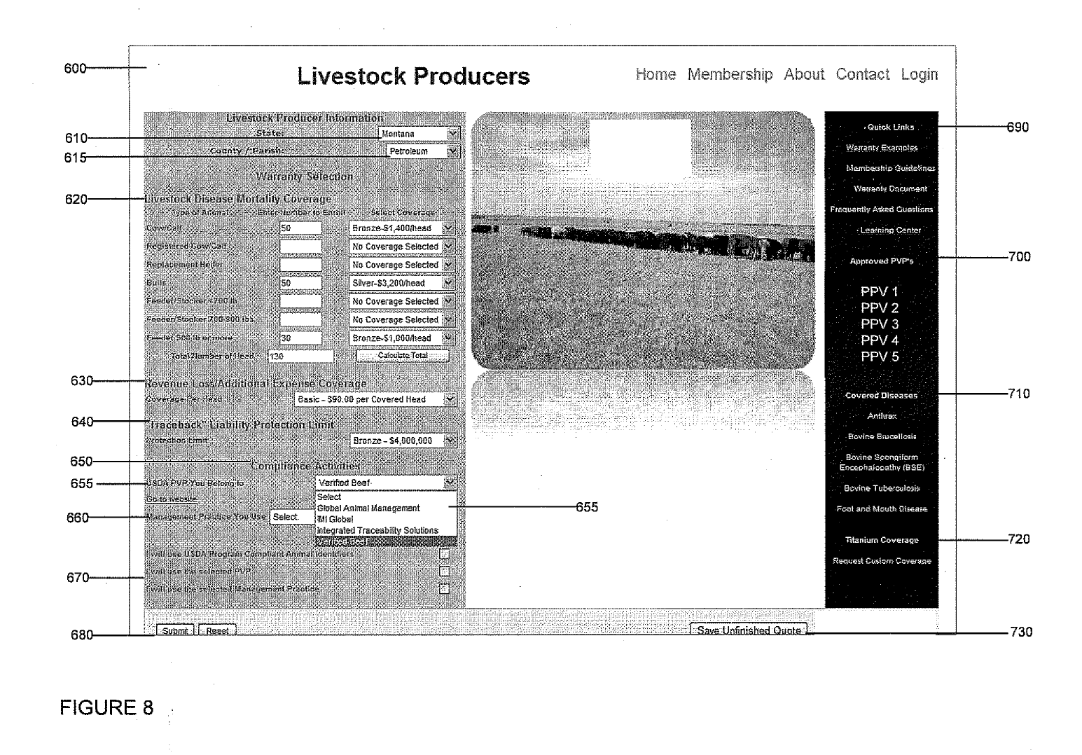

FIGS. 8-10 further illustrate the operable functionality of the above-described compliance activities selection tool 650 that facilitates selection, by the livestock producer, of various compliance activities options, including the process verified program (“PVP”) that the livestock producer belongs to 655. For example, as illustrated in FIG. 8, the livestock producer can select, for example, the USDA PVP that the livestock producer belongs to 655. Potential PVP selections can include, by way of example only, Global Animal Management, IMI Global, Integrated Traceability Solutions, and Verified Beef, or any other USDA PVP as is known and understood by those skilled in the art. In the exemplary embodiment of the present invention illustrated by FIG. 8, the livestock producer selected Verified Beef 655 by providing input through a user interface input device using the compliance activities selection tool 650.

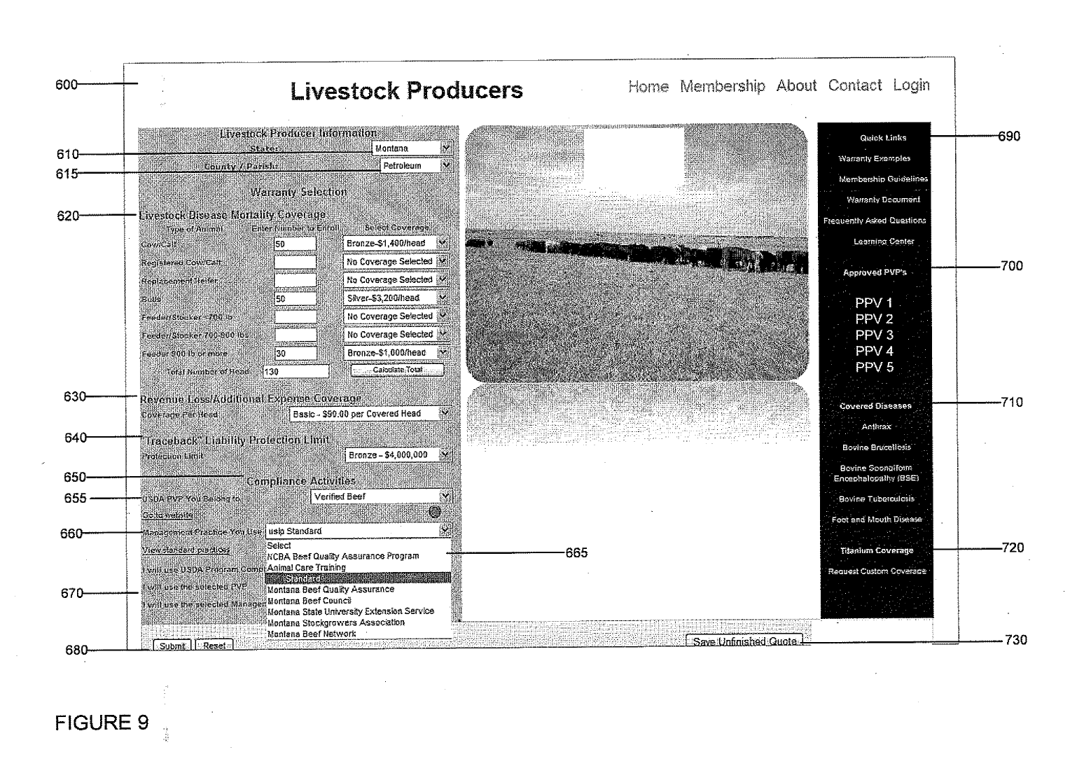

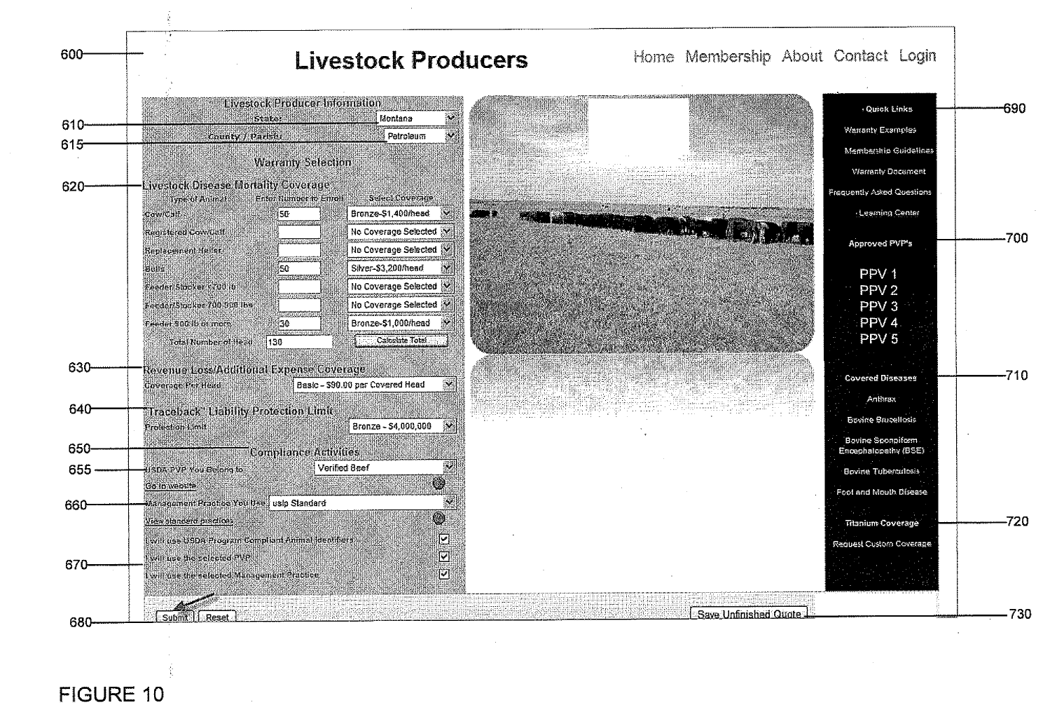

FIG. 9, for example, illustrates that the livestock producer can select the management practice that the livestock provider uses. Potential management practice selections can include, by way of example only, NCBA Beef Quality Assurance Program, Animal Care Training, Standard, Montana Beef Quality Assurance, Montana Beef Council, Montana State University Extension Service, Montana Stockgrowers Association, the Montana Beef Network, and any other recognized management practice as is known and understood by those skilled in the art. In the exemplary embodiment of the present invention illustrated by FIG. 9, the livestock producer selected a Standard management practice by providing input through a user interface input device using the compliance activities selection tool 650. FIG. 10 also further illustrates the functionality of the compliance activities selection tool 650 according to exemplary embodiments of the present invention. The compliance activities selection tool 650 can, for example, ask the livestock producer to affirm several statements by selecting a user interface click box using a user interface input device as is known and understood by those skilled in the art. As illustrated in FIG. 10, the livestock producer can be asked, for example, to affirm the following statements: (1) I will use the USDA Program Compliant Animal Identifiers; (2) I will use the selected PVP; and (3) I will use the selected Management Practice. These are merely examples of the virtually unlimited array of statements the livestock producer can be asked to affirm using the compliance activities selection tool 650 according to exemplary embodiments of the present invention. Some exemplary embodiments of the present invention can prevent the livestock producer from purchasing an individualized, customized warranty product if the livestock producer refuses to affirm any of the presented statements using the compliance activities selection tool 650.

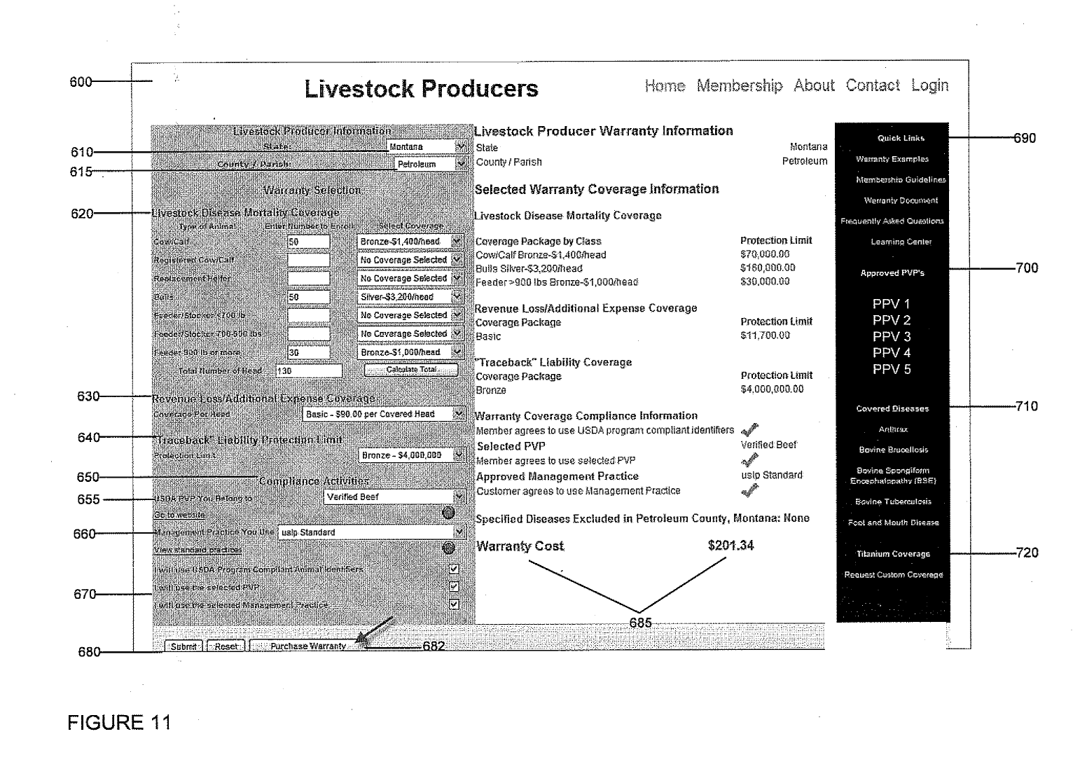

As is perhaps best illustrated by FIG. 11, once the livestock producer finishes providing input to select and customize an individual, customized livestock warranty product, via a user interface input device using the graphical user interface 600, the livestock producer then can use the user interface “SUBMIT” button 680 to submit all of the livestock producer's selected options. Responsive to the livestock producer pressing, clicking, or otherwise selecting the “SUBMIT” user interface button using a user interface input device, exemplary embodiments of the present invention can display a summary of the livestock provider's selected, customized, individual livestock warranty product 685. The summary of the livestock provider's selected, customized, individual livestock warranty product can display, on a display device adapted to be in communication with a livestock producer computer, livestock producer warranty information, including the state and county or parish where the livestock producer's herd is located, the selected livestock warranty coverage information, including, for example, the producer-selected livestock disease mortality coverage, the producer-selected revenue loss and additional expense coverage, the producer-selected traceback liability coverage, the producer-inputted warranty coverage compliance information, and the livestock warranty product cost. As illustrated in FIG. 11, the total cost for the livestock producer's selected, customized livestock warranty product is $201.34. If the livestock provider approves of the selected, customized, individual livestock warranty product summary and the associated cost, the livestock provider can indicate assent by pressing, clicking, or otherwise selecting the “PURCHASE WARRANTY” user interface button 682 using a user interface input device.

According to various exemplary embodiments of the present invention, upon receiving input from the livestock producer indicating that the livestock producer would like to purchase the selected, customized, individual livestock warranty product, a purchasing graphical user interface 740 can appear on a display device adapted to be in communication with a livestock producer computer. The purchasing graphical user interface 740, can include various user input selection buttons, such as a “WARRANTY DOCUMENT” button 760 for retrieving and displaying a visual copy of the livestock warranty product document to be purchased by the livestock producer, a “SIGNATURE PAGE” button 762 for retrieving a signature page associated with the selected, customized, livestock warranty product to be purchased by the livestock producer, a “COMPLETE TRANSACTION AND PAY FOR THIS WARRANTY” button 766 for facilitating final steps and payment for the selected, customized, individual livestock warranty product, and a “CANCEL THIS WARRANTY” button 768 for facilitating the livestock producer's ability to cancel the transaction prior to purchasing the selected, customized, individual livestock warranty product. Such user interface buttons are operable by the livestock provider using a user interface input device such as a mouse, keyboard, touch pad, pen, touch screen, or other device as is known and understood by those skilled in the art. The user interface buttons are operable as is known and understood by those skilled in the art. In addition, the purchasing graphical user interface 740 can further include, for example, an input field for an identifier to identify the selected, customized, individual warranty product 764.

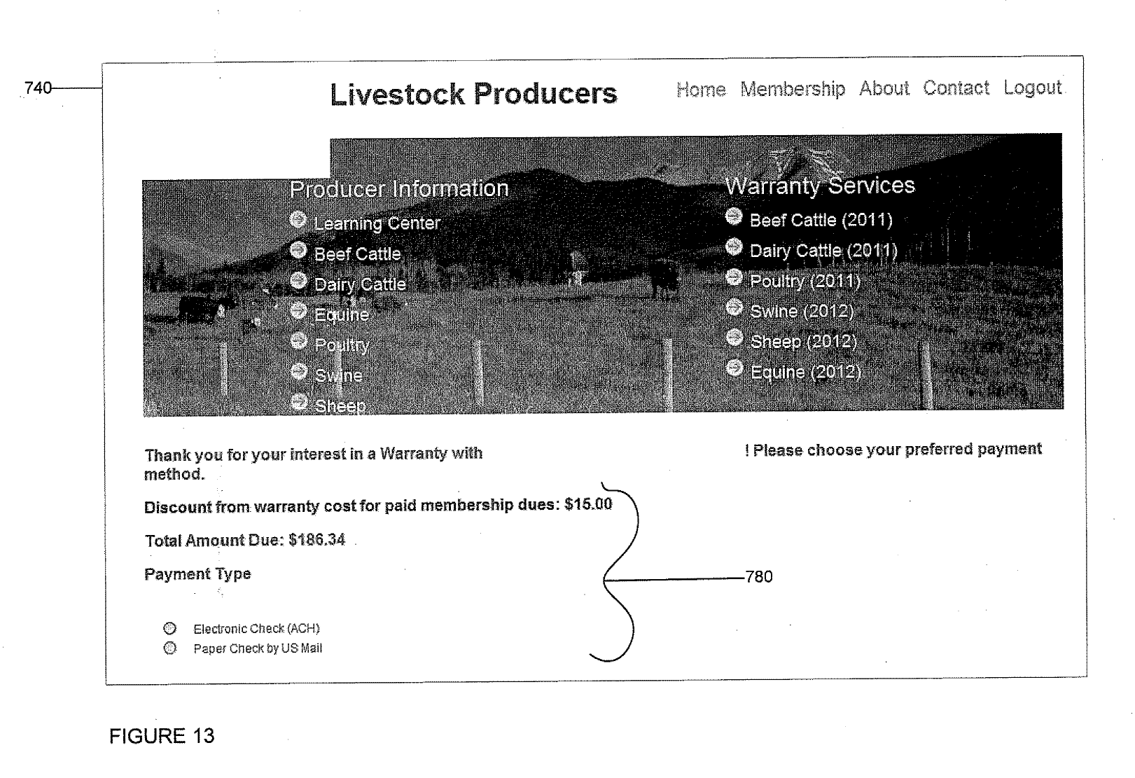

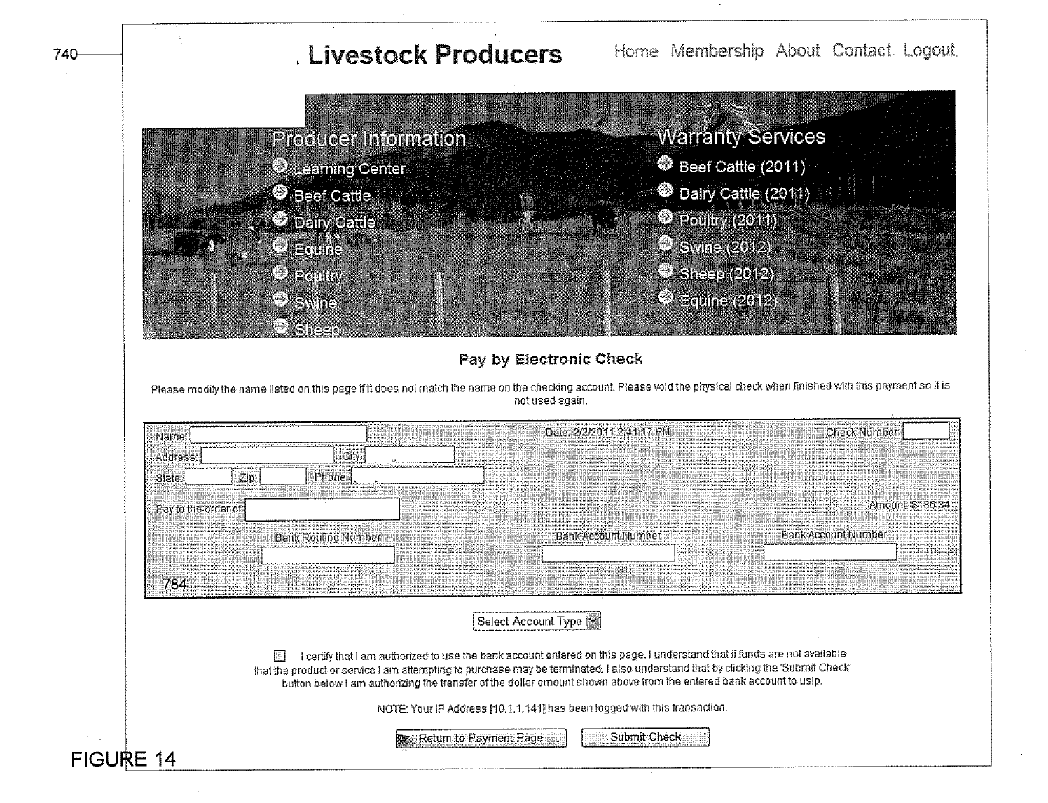

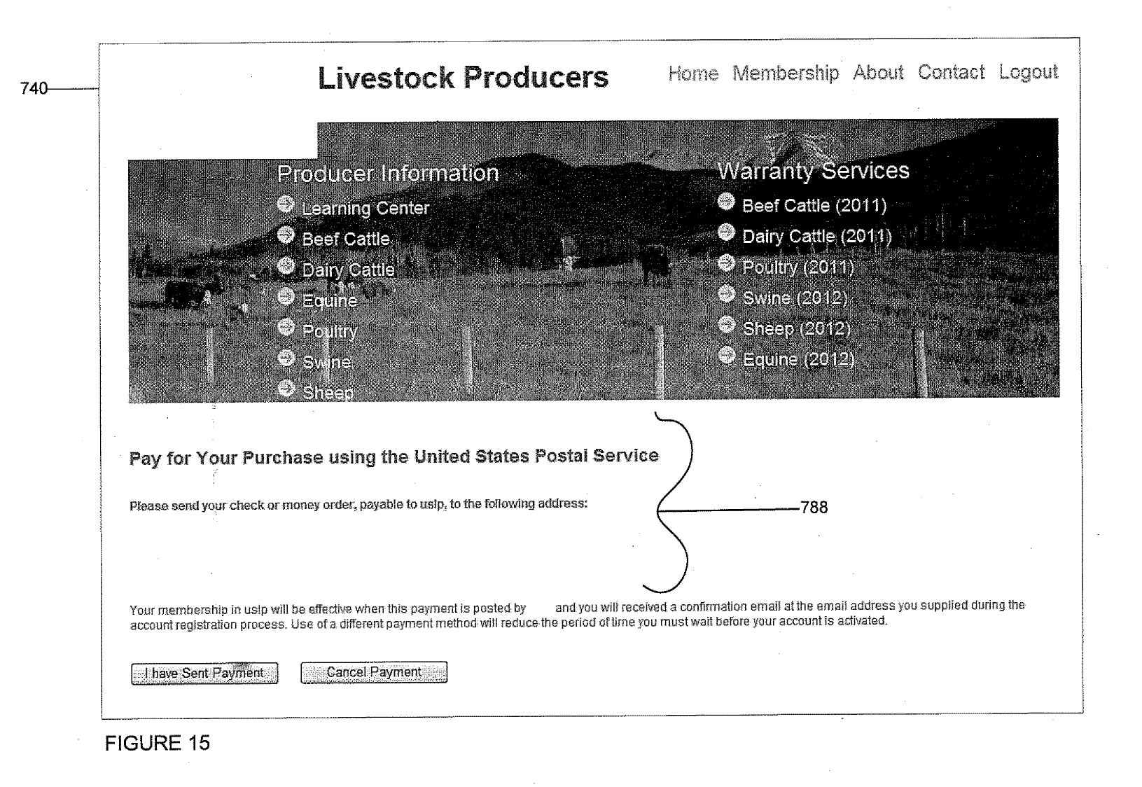

FIGS. 13 and 14 illustrate two exemplary ways that a livestock producer can pay for a selected, customized individual livestock warranty product according to various embodiments of the present invention. Specifically, FIG. 13 illustrates payment options including, for example, electronic check (ACH) and paper check by U.S. mail 780, as is known and understood by those skilled in the art. Livestock providers, however, under various embodiments of the present invention, can pay for selected, customized, individual warranty products using any payment processing mechanism, including, without limitation, electronic check, ACH, debit card, credit card, gift card, coupon card, coupon, paper check by U.S. mail, credit card by U.S. mail, debit card by U.S. mail, Internet cash, Internet payment mechanisms such as PayPal, and any other payment mechanism now known or herein after developed as is known and understood by those skilled in the art. FIG. 14, by way of example, illustrates payment by electronic check 784. FIG. 15, by way of example, illustrates an exemplary method for a livestock producer to confirm that the livestock producer has sent payment through the mail using the United States Postal Service 788.

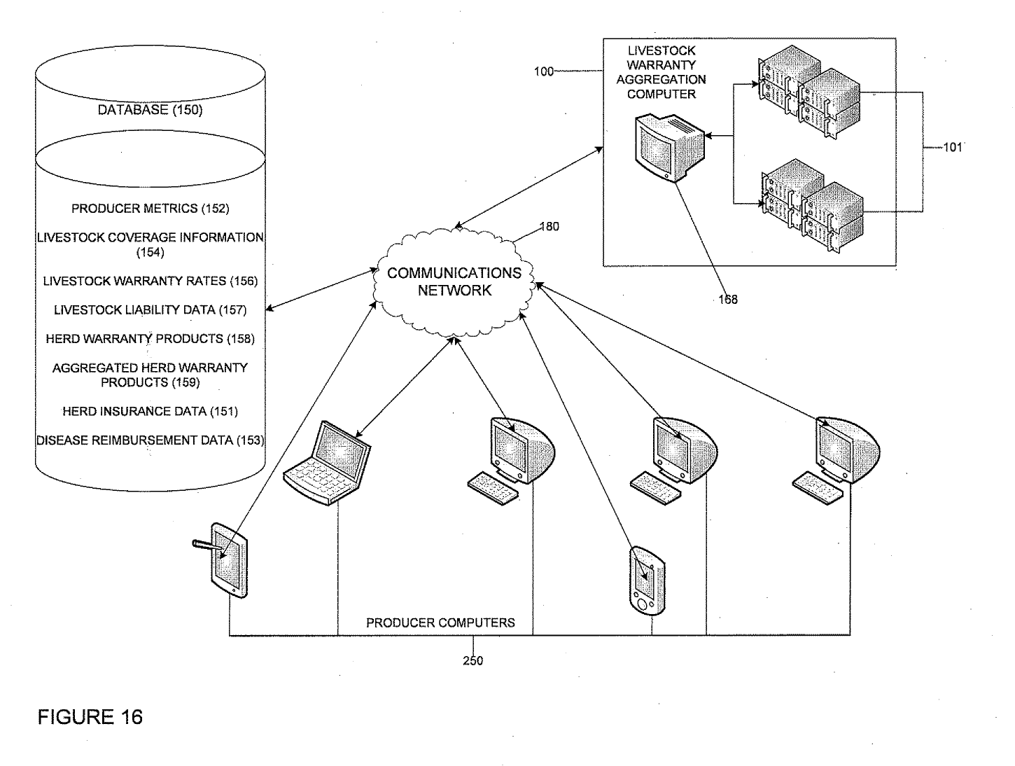

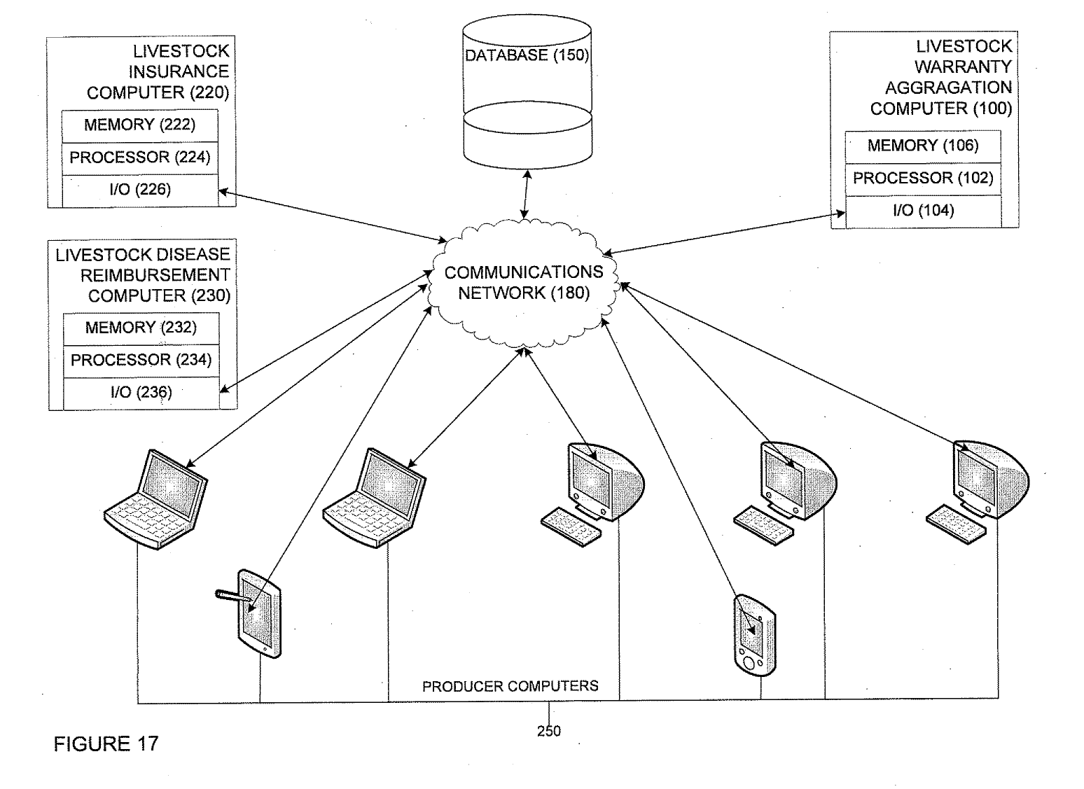

As is perhaps best illustrated by FIGS. 16-17, various exemplary embodiments of the present invention beneficially can include a warranty aggregation system to aggregate a plurality of customized livestock warranty products so that each of the plurality of customized livestock warranty products is provided to different owners of different herds of a plurality of herds and so that a collective risk product is produced for collective risk management. The plurality of customized livestock warranty products can be selected, customized, and purchased, for example, by one or more livestock producers according to various exemplary embodiments of the present invention as illustrated in FIGS. 3-15.

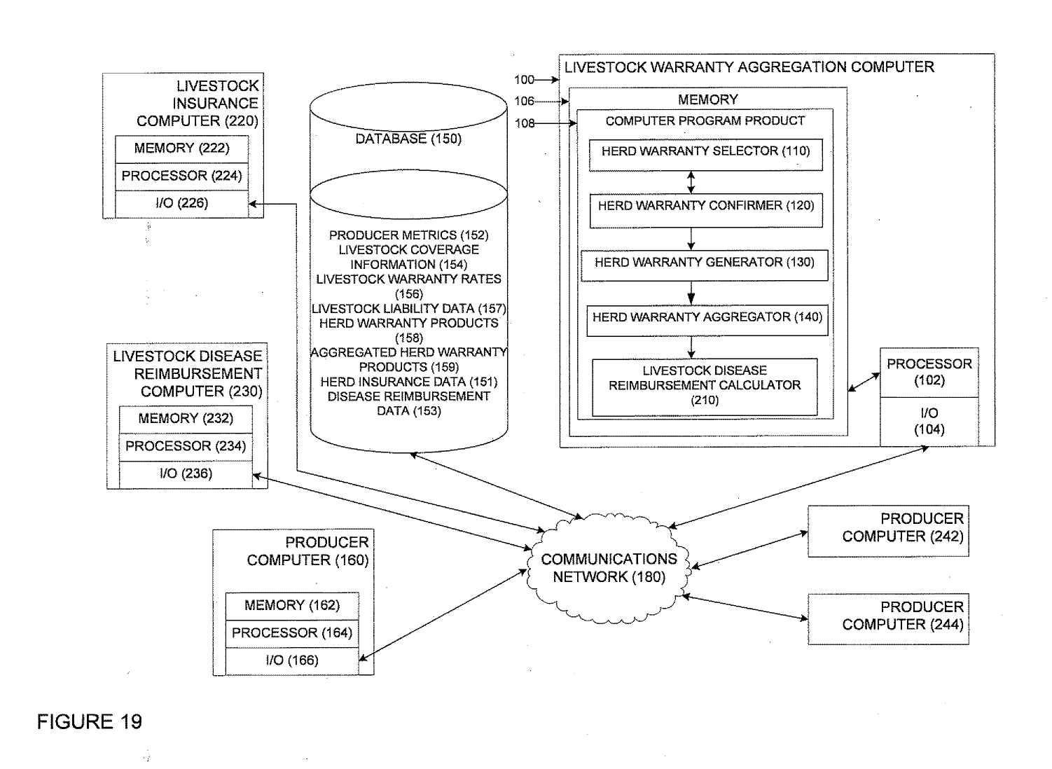

Such a system can include, for example, a communications network 180, a plurality of producer computers 250, a livestock warranty aggregation computer 100, and a database 150. The communications network 180 can include a telephony network, a wireline network, a wireless network, a wide area network, a local area network, an infrared network, a radio-frequency network, an optical network, or any other communications network now or hereinafter created as is known and understood by those skilled in the art. Each of the plurality of producer computers 250 allows a human user, such as a livestock producer, to interact with the warranty aggregation system. The human user can be, for example, an owner of livestock or an employee or agent thereof. The human user, however, is not limited to owners of livestock or livestock producers. Any human being can be a human user. That is, according to other exemplary embodiments of the present invention, the human user can be an agricultural farmer, a share cropper, a planter, a rancher, or any other person working with agricultural products and animals as is known and understood by those skilled in the art. Each of the user terminals 250 allows such a human user, for example, to select customized livestock warranty product parameters and confirm the purchase of a warranty product based on a warranty proposal, as is described herein with respect to the herd warranty aggregator (shown as 140 in FIG. 19).

Each of the plurality of producer computers 250 can be, for example, any type of stationary or portable personal computing device such as a desktop computer, laptop computer, micro computer, mini computer, netbook computer, ultra-mobile computer, tablet computer, handheld computer, mobile telephone, personal digital assistant (PDA), so-called “smartphone,” or any other computing device intended to be operated directly by an end user with no intervening computer operator as is known and understood by those skilled in the art. Each of the plurality of producer computers 250 can include, for example, a keyboard, a mouse, a graphical user interface device, a display, a microphone, electronic speakers, a modem, a LAN card, a computer graphics card, a printer, a scanner, a disk drive, a tape drive, a camera, a Wi-Fi card, a PCMCIA card, or any other peripheral device as is known and understood by those skilled in the art. If the producer computer is a mobile device, as is known and understood by those skilled in the art, the mobile device can include, but is not limited to, a cellphone device, a handheld device, a handheld computer, a palmtop, a handheld device, or any other mobile computing device. Such a mobile device can also include, for example, a display screen with a touch input user interface or a miniature keyboard, or a touch-screen interface. A PDA can include, for example, a processor, memory, an input device, and an output device. Additionally, a PDA, for instance, can include a palmtop computer, a smartphone, a palm device, a portable media player, a Wi-Fi enabled device, a global positioning system device, or any other handheld computing device now or hereinafter developed as is known and understood by those skilled in the art. Embodiments having one or more producer computers as a laptop computer include, for example, the Apple MacBook, MacBook Air, and MacBook Pro product families; the Dell Inspiron and Latitude product families, the Lenovo ThinkPad and IdeaPad product families, the Panasonic Toughbook product families, and the Toshiba Satellite product families. Examples of embodiments having one or more producer computers 250 as a smartphone include, for example, the iPhone 3GS and the iPhone 4 by Apple Computer, Inc. of Cupertino, Calif. and the Droid by Motorola, Inc. of Schaumburg, Ill.

As is illustrated in FIG. 16, the livestock warranty aggregation computer 100 can include a graphical user interface device 168 and can be a computer cluster or computer farm 101. The graphical user interface device can include, for example, a CRT monitor, a LCD monitor, a LED monitor, a plasma monitor, an OLED screen, a television, a DLP monitor, a video projection, a three-dimensional projection, a holograph, a touch screen, or any other type of user interface which allows the one of the plurality of users to interact with one of the plurality of producer computers 250 using images as is known and understood by those skilled in the art.

According to various exemplary embodiments of the present invention, the database can be any database structure as is known and understood by those skilled in the art. The databases discussed herein, including database 150, can be, for example, any sort of organized collection of data in digital form. Databases, including database 150, can include the database structure as well as the computer programs that provides database services to other computer programs or computers, as defined by the client-server model, and any computer dedicated to running such computer programs (i.e., a database server). An exemplary database model, for example, is Microsoft SQL Server 2008 R2. Databases can include a database management system (DBMS) consisting of software that operates the database, provides storage, access, security, backup and other facilities. DBMS can support multiple query languages, including, for example, SQL, XQuery, OQL, LINQ, JDOQL, and JPAQL. Databases can implement any known database model or database models, including, for example, a relational model, a hierarchical model, a network model, or an object-oriented model. The DBMS can include Data Definition Language (DDL) for defining the structure of the database, Data Control Language (DCL) for defining security/access controls, and Data Manipulation Language (DML) for querying and updating data. The DBMS can further include interface drivers, which are code libraries that provide methods to prepare statements, execute statements, fetch results, etc. Examples of interface drivers include ODBC, JDBC, MySQL/PHP, FireBird/Python. DBMS can further include a SQL engine to interpret and execute the DDL, DCL, and DML statements, which includes a compiler, optimizer, and executor. DBMS can further include engine a transaction engine to ensure that multiple SQL statements either succeed or fail as a group, according to application dictates. DBMS can further include a relational engine to implement relational objects such as Table, Index, and Referential integrity constraints. DBMS can further include a storage engine to store and retrieve data from secondary storage, as well as managing transaction commit and rollback, backup and recovery, etc.

Data stored in fields of the databases can be updated as needed, for example, by a user with administrative access to the database to add new data to the libraries in the database as they become supported. It will be appreciated by those having skill in the art that data described herein as being stored in the databases can also be stored or maintained in non-transitory memory and accessed among subroutines, functions, modules, objects, program products, or processes for example, according to objects and/or variables of such subroutines, functions, modules, objects, program products or processes. Any of the fields of the records, tables, libraries, and so on of the database can be multi-dimensional structures resembling an array or matrix and can include values or references to other fields, records, tables, or libraries. Any of the foregoing fields can contain either actual values or a link, a join, a reference, or a pointer to other local or remote sources for such values.

Database 150 can be, for example, a single database, multiple databases, or a virtual database, including data from multiple sources, for example, servers on the World Wide Web. According to various exemplary embodiments of the present invention, for example, and as illustrated by FIG. 16, database 150 can include at least eight databases, including a producer metrics database 152, a livestock coverage information database 154, a livestock warranty rates database 156, a livestock liability data database 157, a herd warranty products database 158, an aggregated herd warranty products database 159, a herd insurance data database 151, and a disease reimbursement data database 153. The producer metrics database 152, can be configured, for example, to store any data related to producer metrics, including producer names, producer addresses, producer membership information, producer payment records, data related to a producer's herds or livestock, data related to a producer's compliance with quality control and bio-security standards, data related to livestock warranty products selected, customized, or purchased by a livestock producer, and any other information related to a producer, including a livestock producer, as is known and understood by those skilled in the art. The livestock coverage information database 154 can include, for example, any data related to the scope or extent of coverage of various livestock warranty products. For example, the livestock coverage information database 154 can include data related to the type of animals covered, the amount of coverage provided, the cost of various types of coverage, the liability of various types of coverage, or any other information related to warranty coverage as is known and understood by those skilled in the art. The livestock warranty rates database 156 can include any data or information related to the cost of livestock warranty products. The livestock liability data database 157 can include, for example, any data or information related to the liability coverage of various livestock warranty products. For example, the livestock liability data database 157 can include, for example, the amount of coverage that a particular warranty product provides for bulls. The herd warranty products database 158, can include any data related to one or more customized, individual livestock warranty products selected, customized, and purchased by one or more livestock producers. That is, this database can store, for example, data related to the customized warranty products after such products are selected and purchased by one or more producers. The herd warranty products database 158 beneficially facilitates tracking and confirmation of warranty coverage associated with each of the one or more producers. The aggregated herd warranty products database 159 includes data related to one or more aggregate warranty products stored by the warranty aggregation system according to exemplary embodiments of the present invention. The herd insurance data database 151 includes data related to warranty coverage provided by each of the one or more aggregate warranty products. The disease reimbursement data database 153 includes data related to any government indemnities for livestock due to the occurrence of a disease event.

As is perhaps best illustrated by FIG. 17, the livestock warranty aggregation computer 100 can further include at least a memory 106, a processor 102, and an input/output device 104. The warranty aggregation system can also include a livestock insurance computer 220 having at least a memory 222, a processor 224, and an input/output device 226, and a livestock disease reimbursement computer 230 having at least a memory 232, a processor 234, and an input/output device 236. Each of the livestock insurance computer 220, the livestock disease reimbursement computer 230, and the livestock warranty aggregation computer 100, can be adapted to be in communication with each other and the database 150 via the communications network 180.

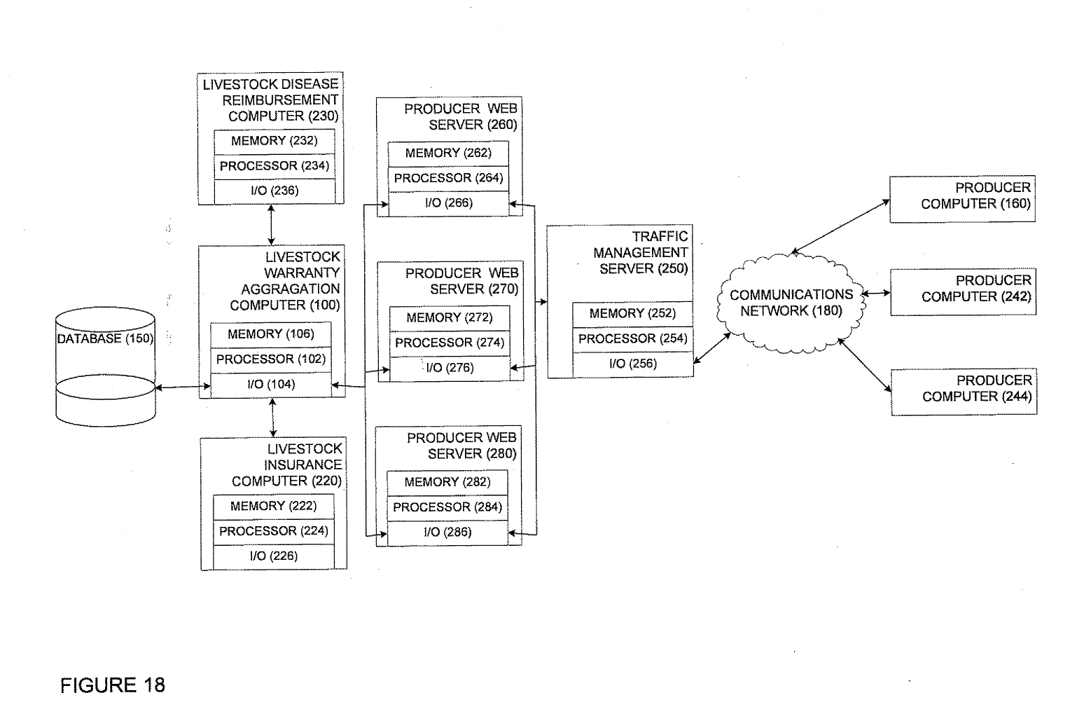

Moreover, as is perhaps best illustrated in FIG. 18, the warranty aggregation system can further include, for example, a traffic management server 250, having at least a memory 252, a processor 254, and an input/output device 256 that is adapted to be in communication with one or more producer web servers 260, 270, 280, each having at least a memory 262, 272, 282, a processor 264, 274, 284, and an input/output device 266, 276, 286. The one or more producer web servers can be adapted to be in communication with the livestock warranty aggregation computer 100, which in turn can be adapted to be in communication with the livestock disease reimbursement computer 230, the livestock insurance computer 220, and the database 150. The traffic management server 250 can, in turn, be adapted to be in communication with one or more producer computers 160, 242, 244 via the communications network 180. According to various exemplary embodiments of the present invention, the traffic management server 250 can be configured to analyze incoming data from the one or more producer computers 160, 242, 244, and route the incoming traffic from the one or more producer computers 160, 242, 244 to one of the one or more producer web servers 260, 270, 280 based on the quantity of incoming data traffic and the quantity of data traffic currently being serviced by each of the one or more producer web servers 260, 270, 280. Advantageously, each of the producer web servers 260, 270, 280 can be configured, for example, to display on one of the one or more producer computers 160, 242, 244 via the communications network 180, a graphical user interface 600 to facilitate selection, customization, confirmation, and purchase of an individualized, customized warranty product by a livestock producer for one or more herds of beef cattle to be aggregated with one or more other individualized, customized warranty products for one or more herds of beef cattle according to an exemplary embodiment of the present invention as further described with reference to FIGS. 3-15.

As is perhaps best illustrated by FIG. 19, a producer computer 160, 242, 244 can include, according to various exemplary embodiments of the present invention, at least a memory 162, a processor 164, and an input/output device 166. As used herein, the processor 164, 102, 224, 234 can include, for example, one or more micro processors, microcontrollers, and other analog or digital circuit components configured to perform the functions described herein. The processor 164, 102, 224, 234 is the “brains” of the respective computer 160, 100, 220, 230, and as such, can execute computer program product or products. For example, the processor 102 in the livestock warranty aggregator computer can execute computer program product or products 108 stored in memory 106 of the livestock warranty aggregation computer 100, including, for example, a herd warranty selector program product 110 to facilitate the selection of a warranty product by a producer, a herd warranty confirmer program product 120 to confirm the warranty product selected by the producer, a herd warranty generator program product 130 to generate the warranty confirmed by the producer, a herd warranty aggregator program product 140 to aggregate the warranty product selected and confirmed by the producer with one or more other warranty products selected by one or more other producers, and a livestock disease reimbursement calculator program product 210 to calculate and determine the reimbursement payments owed to one of the one or more producers based on the warranty product selected and confirmed by the one of the one or more producers and the one of the one or more producer's livestock loss attributed to a disease event.

The processor 102, 224, 234, 164 can be any commercially available terminal processor, or plurality of terminal processors, adapted for use in or with the producer computer 160. The processor 102, 224, 234, 164 can be, for example, the Intel® Xeon® multicore terminal processors, Intel® micro-architecture Nehalem, and AMD Opteron™ multicore terminal processors, Intel® Core® multicore processors, Intel® Core 2 Duo® multicore processors, and other processors with single or multiple cores as is known and understood by those skilled in the art. The processor 102, 224, 234, 164 can be operated by operating system software installed on memory 106, 222, 232, 162, such as Windows Vista, Windows 7, Windows XP, UNIX or UNIX-like family of systems, including BSD and GNU/Linux, and Mac OS X. The processor 102, 224, 234, 164 can also be, for example the TI OMAP 3430, Arm Cortex A8, Samsung S5PC100, or Apple A4. The operating system for the processor 102, 224, 234, 164 can further be, for example, the Symbian OS, Apple iOS, Blackberry OS, Android, Microsoft Windows CE, Microsoft Phone 7, or PalmOS.

The livestock warranty aggregation computer 100 can further include a non-transitory memory or more than one non-transitory memories (referred to as memory 106 herein). Memory 106 can be configured, for example, to store data, including computer program product or products, which include instructions for execution on the processor 102. Memory 106, can include, for example, both non-volatile memory, e.g., hard disks, flash memory, optical disks, and the like, and volatile memory, e.g., SRAM, DRAM, and SDRAM as required to support embodiments of the instant invention. As one skilled in the art will appreciate, though the memory 106 is depicted on, e.g., a motherboard, of the livestock warranty aggregation computer 100, the memory 106 can also be a separate component or device, e.g., flash memory, connected to the livestock warranty aggregation computer 100 through an input/output unit 104 or a transceiver. As one skilled in the art will understand, the program product or products, along with one or more databases, data libraries, data tables, data fields, or other data records can be stored either in memory 106 or in separate memory (also non-transitory), for example, associated with a storage medium such as a database (not pictured) locally accessible to the livestock warranty aggregation computer 100, positioned in communication with the livestock warranty aggregation computer 100 through the I/O 104.

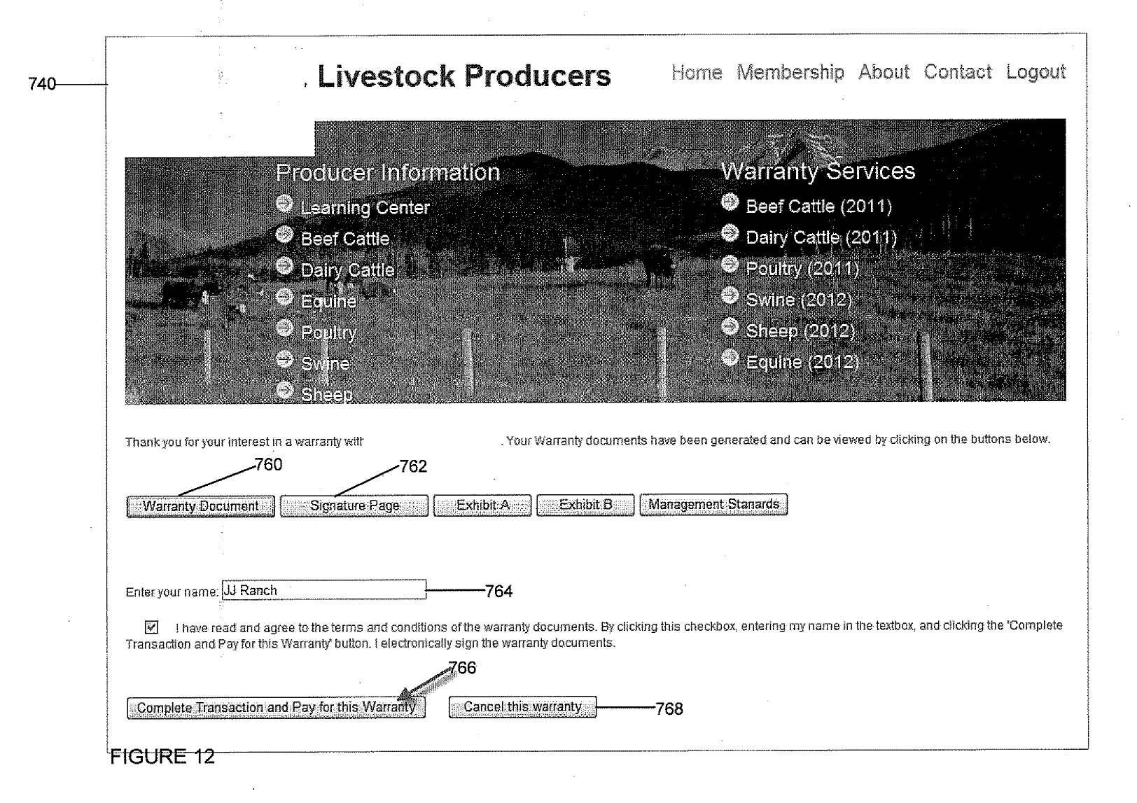

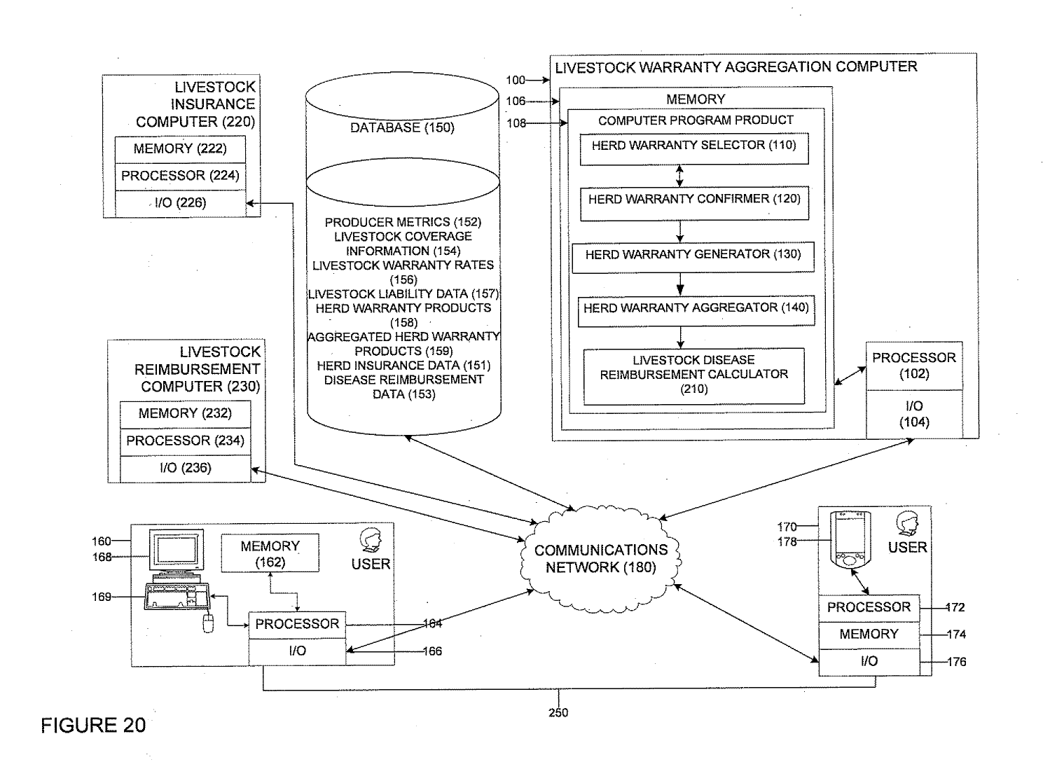

The memory 162 of the producer computer 160, for example, can further include applications, drivers, modules, libraries, or engines that allow the producer computer 160 to have interactive client-side interface capabilities, including, for example a web browser application, such as Microsoft® Internet Explorer® by Microsoft Corporation of Redmond, Wash., having capabilities for processing interactive content, such as Java, JavaScript, or Flash plug-ins or scripts. Those having skill in the art will appreciate that interactive interfaces, such as the warranty selection graphical user interface (600 in FIGS. 3-11) and the warranty confirmation and payment graphical user interface (740 in FIGS. 12-15) may be in whole or in part dynamically generated at a server computer, such as the livestock warranty aggregation computer 100 or one of the one or more producer web servers 260, 270, 280 adapted to be in communication with the livestock warranty aggregation computer 100, using server-side processing (such as PHP, ASP, ASP.NET) and delivered to the producer computer 160 in static mark-up language, such as HTML, for display at the producer computer 160 using the web browser and a display peripheral device, as is perhaps best illustrated as 168 in FIG. 20. Those having skill in the art will further appreciate that interactive interfaces, such as the warranty selection graphical user interface (600 in FIGS. 3-11) and the warranty confirmation and payment graphical user interface (740 in FIGS. 12-15) may be in whole or in part statically generated at a server, such as the livestock warranty aggregation computer 100 or one of the one or more producer web servers 260, 270, 280 adapted to be in communication with the livestock warranty aggregation computer 100 and delivered to the producer computer 160 for processing by the producer computer 160 using client-side processing (such as Java, JavaScript, or Flash) for display at the producer computer 160 using the web browser and the display peripheral device 168.

As one skilled in the art will appreciate, and is perhaps best illustrated by FIG. 20, both memory 162, 174 and the processor 164, 172, can also include, for example, components (e.g., drivers, libraries, and supporting hardware connections) that allow the producer computer 160, 170 to be connected to a display peripheral device 168, 178 and an input peripheral device 169, 178 that allow a user direct access to the processor 164, 172 and the memory 162, 174. The display peripheral device 168 can be, for example, a computer monitor, which may also be known in the art as a display or a visual display unit. The display peripheral device also can include, for example, a display device, which in modern monitors is typically a thin film transistor liquid crystal display (TFT-LCD) thin panel, while older monitors use a cathode ray tube. The display peripheral device 168 can include the display device, the circuitry, and the physical enclosure. The display peripheral device 168 can be used, in connection with interactive client-side interface capabilities residing in memory 162, to display interactive interfaces to a user at the provider computer, such as the warranty selection graphical user interface (600 in FIGS. 3-11) and the warranty confirmation and payment graphical user interface (740 in FIGS. 12-15). As discussed in greater detail above, the display peripheral device can also be a PDA 178 and can function, at the same time, as a display peripheral device, an input peripheral device, and an output peripheral device.

The input peripheral device 169 can be, for example, a computer keyboard, computer mouse, a touch screen (such as a touch screen device comprising display peripheral device 160, 178), a pen device, character recognition device, voice recognition device, or a similar input device that will be known to those having skill in the art that allows the user at the producer computer 160, through mechanical, electrical, or mechanical and electrical means to send discrete or continuous signals to the processor 164. A status or other output associated with input peripheral device 169 can be displayed at the display peripheral device 168, such as, for example, mouse pointer or a keyboard prompt. The output of input peripheral device 169 can be received by the processor 164, for example, as a selection or a command associated with an interactive client-side interface, such as the warranty selection graphical user interface (600 in FIGS. 3-11) and the warranty confirmation and payment graphical user interface (740 in FIGS. 12-15). An interactive client-side interface may be configured, for example, to receive a selection or a command from the input peripheral and, responsive thereto, transmit data, including content input by the user at the input peripheral device 169, as well as other content as directed by the client-side interface, to other servers or systems through the input/output unit 166.

According to various exemplary embodiments of the present invention, the warranty communications network 180 can connect the processor computer 160 to the livestock warranty aggregation computer 100, and can connect other various networked components together. As one skilled in the art will appreciate, the warranty communications network 180 can connect all of the system components using a local area network (“LAN”) or wide area network (“WAN”), or a combination thereof. For example, the livestock warranty aggregation computer 100, livestock insurance computer 220, and livestock reimbursement computer 230 can be privately networked, or privately tunneled over a public network, to allow for faster, more secure communication and better data synchronization between computing nodes. For example, the livestock warranty aggregation computer 100, livestock insurance computer 220, livestock reimbursement computer 230, and database or database server 150 can be networked using a LAN, with or one of the one or more producer web servers 260, 270, 280 adapted to be in communication with the livestock warranty aggregation computer 100 interfacing with the processor computer 160 using a WAN. Accordingly, though not all such configurations are depicted, all are within the scope of various exemplary embodiments of the present invention.

Warranty communications network 180 can include, for example, any public or private network communication paths to support the communications sent and received between the livestock warranty aggregation computer 100 and the processor computer 160, including the public Internet, a private intranet, a virtual private network (VPN) tunneled across the public Intranet, for example, using a network security protocol, such as Netscape's Secure Socket Layer (SSL) protocol. The warranty communications network 180 can be, for example, a telecommunication network including a wire-based telephone network, pager network, cellular network, or a combination thereof, and a computer network. Accordingly, the warranty communications network 180 can be implemented, in whole or in part, over wireless communications network 180. In addition, according to various exemplary embodiments of the present invention, the wireless communications network 180 can be implemented over any of various wireless communication technologies, for example: code division multiplexed access (“CDMA”), time division multiplexed access (“TDMA”), frequency division multiplexed access (“FDMA”), orthogonal frequency division multiplexed access (“OFDMA”), global system for mobile communications (“GSM”), Analog Advanced Mobile Phone System (“AMPS”), Universal Mobile Telecommunications System (“UMTS”), 802.11a/b/g/n (“WiFi”), World Interoperability for Microwave Access (“WiMAX”), or Bluetooth.

A warranty aggregation system according to various exemplary embodiments of the present invention can provide a framework and construct for users, such as, for example, livestock producers, to explore and customize warranty structures reflecting their risk management needs and to purchase a customized warranty products reflecting customized parameters from one or more warranty issuing entities. The warranty aggregation system further allows the one or more warranty issuing entities to aggregate a plurality of individual warranty products purchased by users for the purpose of collective risk management, such as collective reinsurance and collective reimbursement management. The warranty aggregation system further allows a reinsurance provider and a reimbursement provider to engage in transactions, such as reporting transactions and payment transactions, with a single, central entity, i.e., the one or more warranty issuing entities, rather than with several, disparate entities, i.e., the producers. To get started, the member livestock producer can customize the livestock sector and locale to be served by the livestock producer's individual, customized livestock warranty product. Purchased individual, customized warranty products can reflect the risk at the location of the operation and the category and class of livestock raised. Using the system, livestock producers can, for example, indicate their herd size and can elect a mortality coverage valuation for their animals at or above the baseline level. Livestock producers then can choose the level of revenue loss and additional expense coverage appropriate for their operation. Livestock producers, for example, also can choose the level of traceback liability coverage appropriate for their operation. The warranty aggregation system can use livestock producer metrics stored in the livestock producer metrics database 152 to generate a summary of warranty attributes elected by the member and the price for the selected warranty coverage. Such functions can be performed, for example, by the herd warranty confirmer 120.

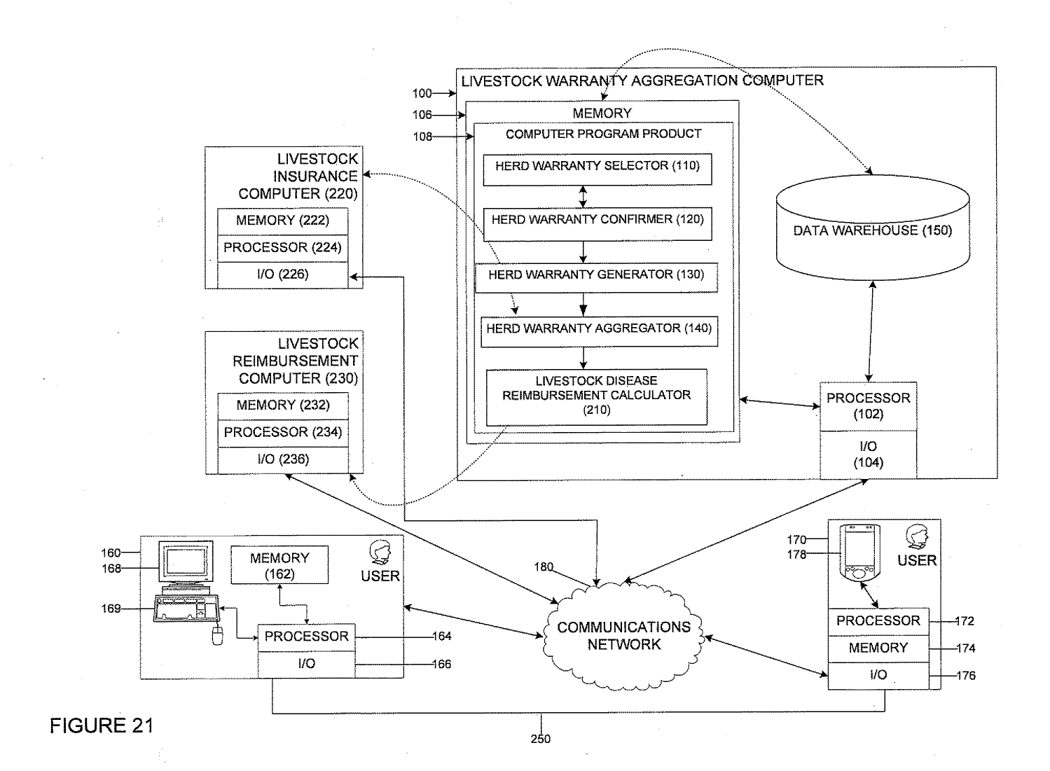

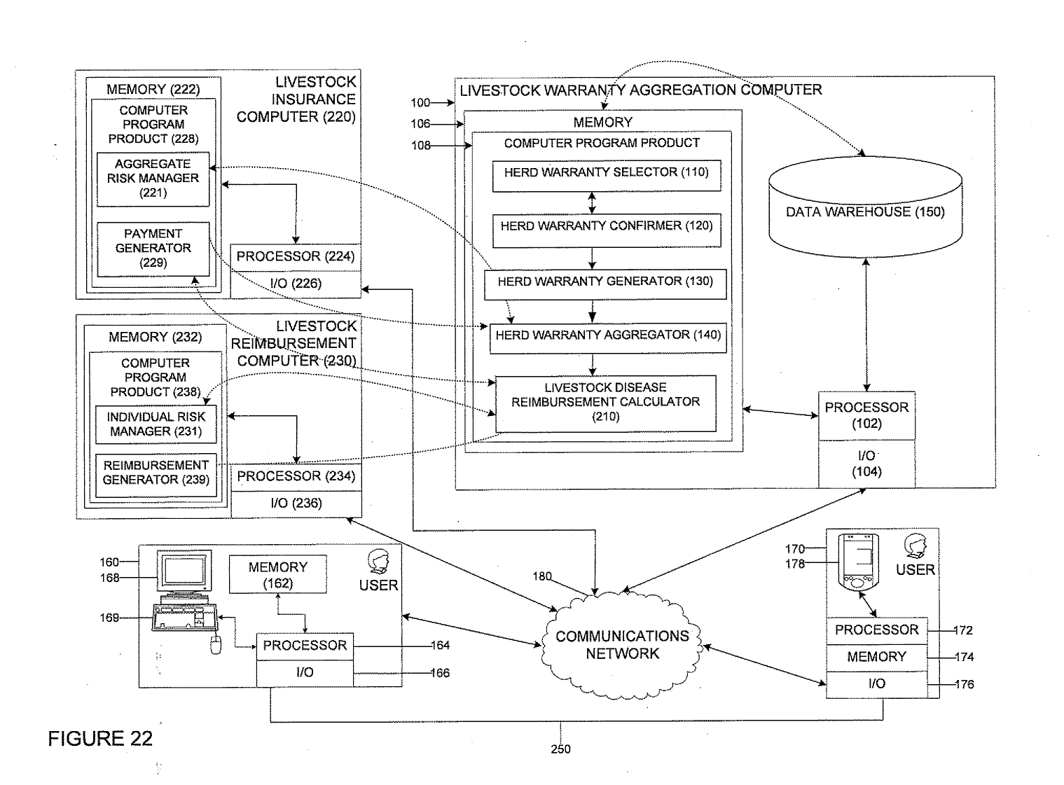

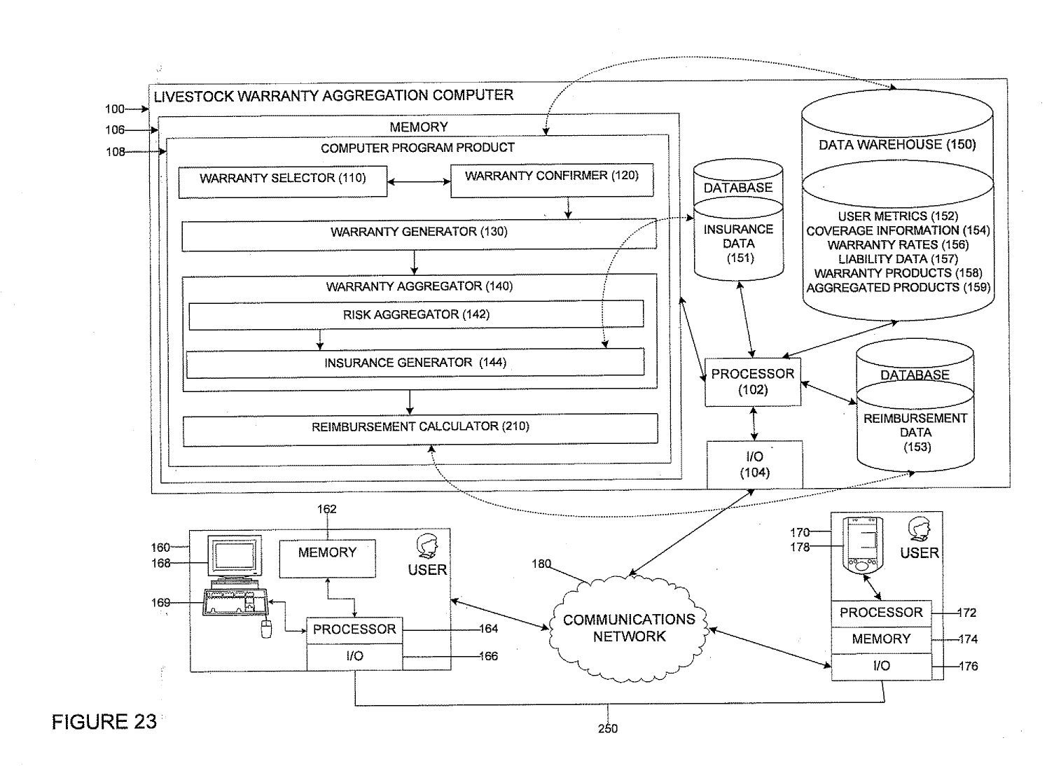

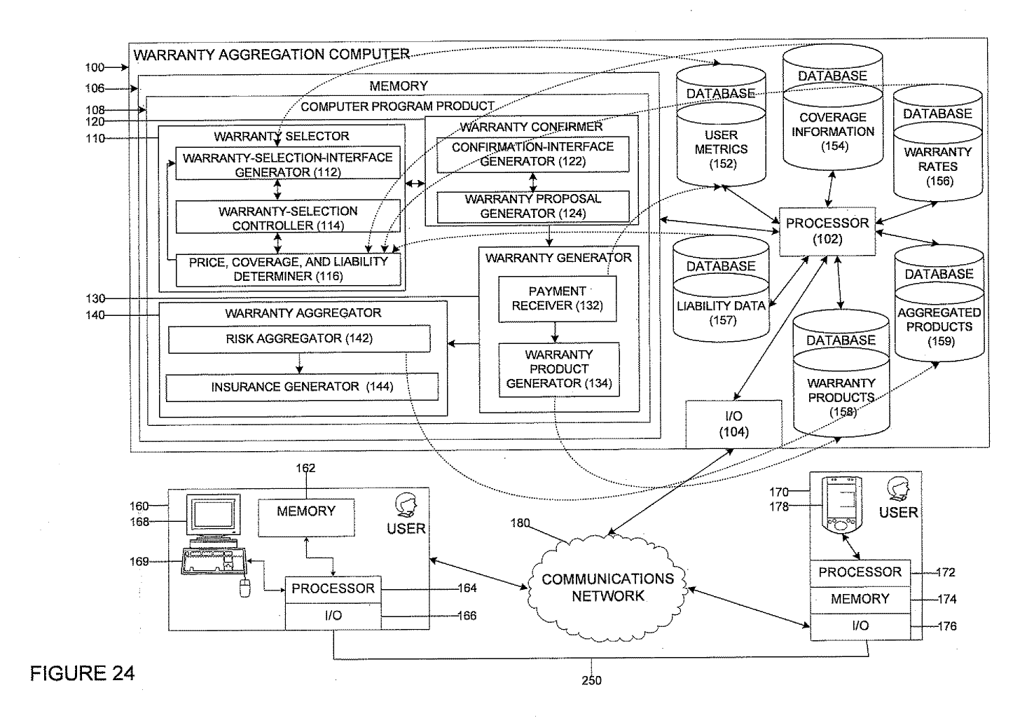

As is perhaps best illustrated by FIGS. 21-23, according to various exemplary embodiments of the present invention, the livestock warranty aggregation computer 100 can be adapted to be in communication with one or more producer computers 160, 170, a livestock insurance computer 220, and a livestock reimbursement computer 230 through the warranty communications network 180. The livestock warranty aggregation computer 100 can be configured, for example, to receive from one of the one or more producer computers 160, 170, customized livestock warranty parameters via the herd warranty selector 110. The herd warranty selector 110 beneficially can store the one or more customized livestock warranty parameters in the database 150. As depicted in FIGS. 21 and 22, the database 150 can be stored within the livestock warranty aggregation computer 100. As depicted in FIGS. 16-20, however, the database 150 can also be a stand-alone database computer or server stored external to the livestock warranty aggregation computer 100 and adapted to be in communication with the livestock warranty aggregation computer 100 via the communications network 180. For simplicity, FIGS. 21 and 22 show the database 150 as a single database. The database 150, however, can have multiple databases, including a user metrics database 152, a coverage information database 154, a warranty rates database 156, a liability data database 157, a warranty products database 158, an aggregated products database 159, an insurance data database 151, and a reimbursement data database 153 according to various exemplary embodiments of the present invention as is perhaps best illustrated by FIGS. 23 and 24.

According to various exemplary embodiments of the present invention, the herd warranty selector 110 can store the customized livestock warranty parameters in the user metrics database 152. As is illustrated in FIG. 24, the herd warranty selector, which is depicted in that figure as a warranty selector 110, further can include a warranty-selection-interface generator 112, a warranty-selection controller 114, and a price, coverage, and liability determiner 116. The warranty-selection-interface generator 112 can, for example, generate a warranty selection graphical user interface such as, for example, the warranty selection graphical user interface 600 illustrated throughout FIGS. 3-11. The warranty-selection-interface generator 112 beneficially can receive user metric data from the user metrics database 152 as well as store additional user metric data collected from the user via the warranty selection graphical user interface 600. The warranty-selection controller 114 can, for example, control the data flow for the user-selection of a customized warranty product. Such a warranty-selection controller 114 can, for example, be adapted to communicate with the warranty-selection-interface generator 112 and the price, coverage, and liability determiner 116 to control the gathering of data input by the user and the data displayed to the user via the warranty selection graphical user interface 600. The price, coverage, and liability determiner 116 can, for example, be configured to receive warranty coverage information from the warranty coverage information database 154, warranty price and rate data from the warranty rates database 156, warranty liability from the warranty liability data database 157, and communicate such data to the warranty-selection controller 114, which, in turn, can provide the information to the warranty-selection interface generator 112 to be displayed to the provider via the warranty selection graphical user interface 600.

The customized livestock warranty parameters collected by the warranty selector 110 then can be analyzed by the herd warranty confirmer 120 to thereby responsively generate a customized warranty product confirmation. The warranty confirmer 120 further can include, for example, a confirmation-interface generator 122 to generate a warranty confirmation and payment graphical user interface (740 in FIGS. 12-15) and a warranty proposal generator 124 to display via the warranty proposal graphical user interface 740 using the confirmation-interface generator 122, a proposed customized warranty based on the customized livestock warranty parameters received from the user via the herd warranty selector 110. The user can select to confirm the proposed customized warranty using the warranty confirmation and payment graphical user interface 740 generated by the confirmation-interface generator 122.

Once the user has confirmed the proposed customized warranty proposed by the warranty proposal generator 124, the warranty generator 130 can, for example, generate a customized warranty product for the user once confirmation of payment has been received by the warranty generator 130. According to exemplary embodiments of the present invention, the warranty generator further can include, for example, a payment receiver 132 and a warranty product generator 134. The payment receiver 132 can, for example, be configured to receive notice of, and confirm payment for, a user's customized warranty product. For example, the payment receiver 132 can be adapted to interface with a computers or servers associated with a bank, an Automated Clearing House (ACH) network or processor, a pre-paid card processor, a credit-card processor, a debit-card processor, a generalized payment processor, an Internet or e-cash payment processor, or any other payment processor as is known and understood by those skilled in the art. As is known and understood by those skilled in the art, ACH is the name of an electronic network for financial transactions in the United States and is regulated by the Federal Reserve. Responsive to such interfacing with a payment processor, the payment receiver 132 can confirm that payment for the customized warranty product has been received from the user and store a record of such payment in the user metrics database 152. Responsive to the payment receiver 132 confirming payment, the warranty product generator 134 can, for example, generate the customized warranty product and store any information related to the customized warranty product in the warranty products database 158. The above describe process for generating a customized warranty product advantageously can be repeated to thereby generate a plurality of customized, individual warranty products.

Responsive to the generation of the plurality of customized, individual warranty products by the warranty product generator 134, the warranty aggregator 140 advantageously can, for example, create a collective risk product by aggregating a plurality of warranty products so that the collective risk product has an aggregate liability value responsive to the sum of the coverage values of each of the plurality of customized, individual warranty products. According to exemplary embodiments of the present invention, the warranty aggregator can include a risk aggregator 142 and an insurance generator 144. The risk aggregator can be configured, for example, to aggregate the plurality of customized, individual warranty products into a single collective warranty product such that the single product can be leveraged by the one or more warranty issuing entities to receive liability insurance protection from a risk retention group at prices vastly lower than that which the one or more users would have received had they sought such insurance from the risk retention group based on their individual warranty product alone rather than after aggregating the plurality of such customized, individual warranty products together. Responsive to creating the collective risk product, the risk aggregator 142 can be configured further to store data relating to the collective risk product in the aggregated products database 159. The insurance generator 144 can, for example, responsive to the creation of the collective risk product by the risk aggregator 142, be adapted to communicate with a risk retention group to obtain a liability insurance policy from such risk retention group that covers the aggregate coverage value of the collective risk product. The risk retention group, for example, can manage a livestock insurance computer that can be used to analyze the collective risk product and generate the liability insurance policy for such collective risk product.

According to exemplary embodiments of the present invention, and as is perhaps best illustrated in FIG. 22, the herd warranty aggregator 140 can be adapted to communicate with a livestock insurance server 220 operated by the risk retention group via the warranty communications network 180. The herd warranty aggregator 140, for example, can transmit information regarding the collective risk product generated by the herd warranty aggregator 140 to the livestock insurance computer 220 to thereby obtain a liability insurance policy sufficient to cover the collective risk product from a risk retention group. The livestock insurance computer can include, for example, an aggregate risk manager computer program product 221 and a payment generator computer program product 229 stored in memory 222 of the livestock insurance computer 220. According to various exemplary embodiments of the present invention, the herd warranty aggregator 140 can transmit to the aggregate risk manager 221 data relating to the collective risk product and receive from the aggregate risk manager 221 data relating to a liability insurance policy sufficient to cover the liability of the collective risk product. In addition, the aggregate risk manager 221 can be configured to generate an invoice for the liability insurance policy and to transmit such invoice to the herd warranty aggregator 140 for payment by the one or more warranty issuing entities. The herd warranty aggregator 140 can then send payment either by electronic or paper means, as is known and understood by those skilled in the art, to the aggregate risk manager 221 in satisfaction of amounts due to the risk retention group for the liability insurance policy.

In the event of a catastrophic disease incident, various exemplary embodiments of the present invention provide for reimbursement for associated losses by the risk retention group in accordance with the terms of the liability insurance policy covering the collective risk product. Accordingly, the livestock disease reimbursement calculator 210 can be configured to provide notice to the payment generator 229 of the catastrophic disease event and the loss of livestock associated with the disease event and covered under the collective risk product. The payment generator 229 then can be configured to transmit payment data (or confirmation of a traditional paper payment) to the livestock disease reimbursement calculator 210. The livestock disease reimbursement calculator 210 then can be configured to calculate and determine the portion of the aggregate payment, received from the payment generator 229 that is attributable to each individual user (i.e., each individual livestock producer).

In some exemplary embodiments of the present invention, the warranty aggregation system can include a livestock reimbursement computer 230 for determining the portion of the aggregate payment, received from the payment generator 229, that is attributable to each individual livestock producer. In such embodiments of the present invention, the livestock reimbursement computer 230 can include an individual risk manager computer program product 231 and a reimbursement generator computer program product 239. In the event of a catastrophic disease incident, the livestock disease reimbursement calculator 210 can, for example, transmit notice of the disease event to the individual risk manager 231 along with information detailing the livestock losses associated with the disease event. Responsive to such notice, the individual risk manager 231 can determine the portion of the aggregate payment, received from the payment generator 229 that is attributable to each individual livestock producer. The reimbursement generator 239 then can generate reimbursement payments for each of the plurality of livestock producers that suffered a livestock loss due to the catastrophic disease event. The reimbursement generator 239 then can transmit payment data to the livestock disease reimbursement calculator 210 to be transmitted to the account of one or more of the plurality of livestock producers so that they can be reimbursed based on the terms of their customized, individual warranty products for losses suffered as a result of the disease event. Notably, according to various exemplary embodiments of the present invention, the features and aspects of the livestock reimbursement server 230 can be wholly included and encapsulated within the livestock warranty aggregation computer 100, such that the two computers are the same computer.

Moreover, although not illustrated in the diagrams, a warranty aggregation system, according to various exemplary embodiments of the present invention, also can include a government server adapted to be in communication with the livestock warranty aggregation computer 100 via the warranty communications network 180. The government server can be configured to receive information concerning livestock destroyed due to a disease event from the livestock warranty aggregation computer 100 and responsively send government-sponsored indemnity payment information for destroyed livestock to the one or more warranty issuing entities through the livestock warranty aggregation computer 100 via the warranty communications network 180.

Although the various computer program product modules, including the herd warranty selector 110, the herd warranty confirmer 120, the herd warranty generator 130, the herd warranty aggregator 140, the livestock disease reimbursement calculator 210, the aggregate risk manager 221, the payment generator 229, the individual risk manager 231, the reimbursement generator 239, the warranty-selection-interface generator 112, the warranty-selection controller 114, the price, coverage, and liability determiner 116, the confirmation-interface generator 122, the warranty proposal generator 124, the risk aggregator 142, the insurance generator 144, the payment receiver 132, and the warranty product generator 134 are described herein as individual computer program product modules, those having skill in the art will appreciate that these computer program product modules may comprise other modules or sub-modules that perform functions described of these computer program product modules. In large-scale implementations or operations, it will be preferable that these computer program product modules comprise several sub-modules according to techniques or programming conventions known to those having skill in the art. The following description will be understood by those having skill in the art to not limit the invention to using any particular type, style, or number of objects, classes, functions, or subroutines over any other object, class, function, or subroutines that will achieve the functions described herein.

More generally speaking, the features of the livestock warranty aggregation computer 100 described herein allow the livestock warranty aggregation computer 100 to generate a warranty product for each individual herd, responsive to the customized warranty parameters for the herd. The warranty product can be generated responsive to a warranty rate table locally accessible to the livestock warranty aggregation computer 100. The livestock warranty aggregation computer 100, further, can aggregate a plurality of warranty products, thereby defining a collective product, so that the warranty products can be managed collectively as is described herein.

According to various exemplary embodiments of the present invention, the livestock warranty aggregation computer 100 can be a server and can include, for example, any type of mainframe, physical appliance, or personal computing device such as rack server, mainframe, desktop computer, or laptop computer, dedicated in whole or in part to running one or more services to serve the needs or requests of client programs which may or may not be running on the same computer. The livestock warranty aggregation computer 100 can be, for example, a dedicated software/hardware system (i.e. a software service running on a dedicated computer) such as an application server, web server, database server, file server, home server, or standalone server. As one skilled in the art will appreciate, though the livestock warranty aggregation computer 100 is shown in some of the diagrams as a single server, it is possible for producer computers 250, livestock disease reimbursement computer 230, and livestock insurance computer 220 to interface with a separate web server, application server, or network server to access the functionality of the livestock warranty aggregation computer 100, for example, through the warranty communications network 180 or the reimbursement communications network (not shown), and such a configuration would be preferred for large-scale implementations.

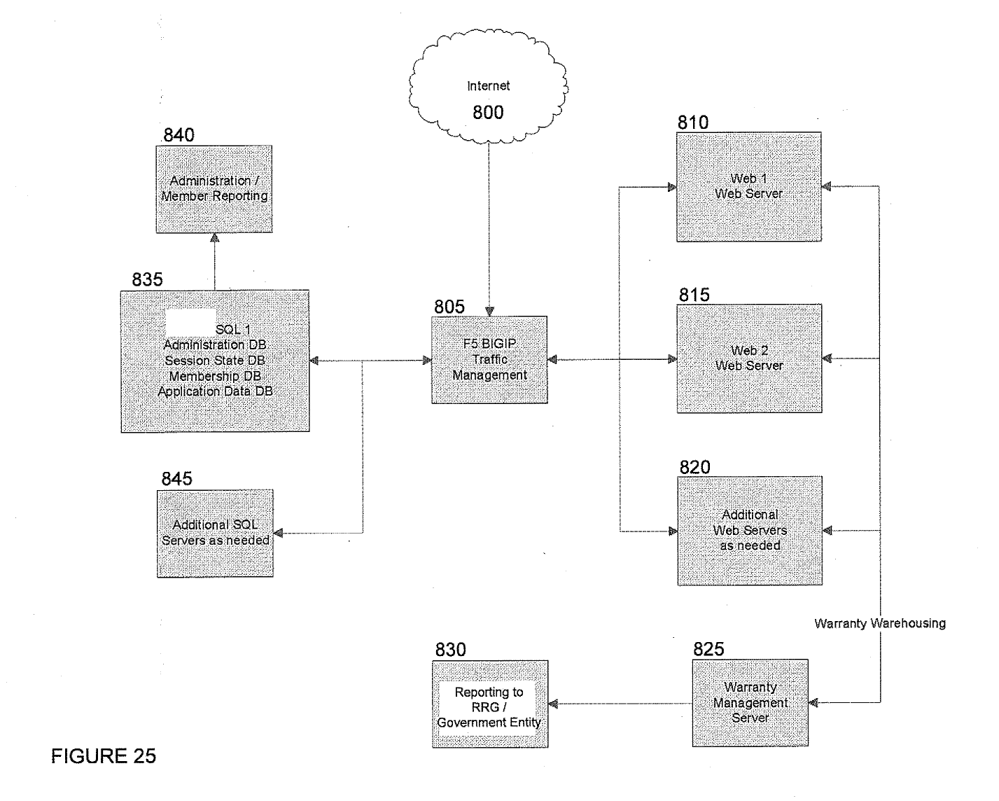

In order to provide the ability to host multiple web and database servers in a web farm, the warranty aggregation system can include a local traffic manager (LTM), such as the Big-IP LTM from F5 805, to serve as a web-platform core, as is perhaps best illustrated in FIG. 25. The LTM 805 can deliver high availability, improved performance, application security, and access control services to applications served by the warranty aggregation server. The LTM 805 removes single points of failure and virtualizes the network and applications using industry-leading L7 intelligence. The LTM 805 can include, for example, rich static and dynamic load balancing methods, dynamic ratio, least connections, and observed load balancing. The LTM 805 can further ensure always-on status, provide scalability, and provide management ease.

The livestock warranty aggregation computer 100 can be in communication with a warranty management server 825 for purposes of warranty warehousing and reporting to the livestock reimbursement computer 230 and the livestock insurance computer 220. The livestock warranty aggregation computer 100 further can be in communication with a risk retention server (not pictured) for purposes of warranty warehousing and reporting to the livestock insurance computer 220. The risk retention server (not pictured) is included in the definition of the livestock insurance computer 220, as the livestock insurance server 220 will be appreciated to include one or more servers by those having skill in the art.

The livestock warranty aggregation computer 100 can be in communication with database 150, either locally through a private LAN connection, or through the warranty communications network 180. The database 150 can contain, for example, tables, libraries, or other data structures for member registration and signup/account data, rate tables, session state, administrative data, membership roster, membership accounting, and liability data. Database 150 can be, for example, a Microsoft SQL server providing database services as an enterprise-class server that providing reliable capabilities when used to support web applications. Microsoft SQL can store, for example, all data required by the aggregator module for administration, session state, membership, and application support.

The livestock warranty aggregation computer 100 can include, for example, a processor 102. The processor 102 can include, for example, one or more microprocessors, microcontrollers, and other analog and/or digital circuit components configured to perform the functions described herein. The processor 102 is the “brains” of the livestock warranty aggregation computer 100, and as such executes computer program product or products, such as the herd warranty aggregator 140, and works in conjunction with the input/output unit 104 (I/O), for example, to direct data to a non-transitory memory 106 and to send data or commands from the non-transitory memory 106 to other connected computers via the warranty communications network 180. The processor 102 can be any commercially available processor, or plurality of processors, adapted for use in or with the livestock warranty aggregation computer 100. Processor 234 can be, for example, the Intel® Xeon® multicore processors, Intel® micro-architecture Nehalem, and AMD Opteron™ multicore processors. Processor 234 can be operated by an operating system software installed on the non-transitory memory 232, such as Windows Server 2008, Windows Vista, Windows 7, Windows XP, UNIX or UNIX-like family of systems, including BSD and GNU/Linux, and Mac OS X.

The livestock warranty aggregation computer 100 can further include a non-transitory memory 106 or more than one non-transitory memories. Non-transitory memory 106 can be configured to store data, including computer program product or products, which include instructions for execution on the processor 106. Non-transitory memory 106 can include both non-volatile memory, e.g., hard disks, flash memory, optical disks, and the like, and volatile memory, e.g., SRAM, DRAM, and SDRAM as required to support embodiments of the instant invention. As one skilled in the art will appreciate, though the non-transitory memory 106 is depicted on, e.g., a motherboard, of the livestock warranty aggregation computer 100, the non-transitory memory 106 may also be a separate component or device, e.g., flash memory, connected to the livestock warranty aggregation computer 100 through the input/output unit 104. As one skilled in the art will understand, the program product or products, along with one or more databases, data libraries, data tables, data fields, or other data records can be stored either in non-transitory memory 106 or in separate memory (also non-transitory), for example, associated with a storage medium such as database 150, positioned in communication with the livestock warranty aggregation computer 100 through the I/O 104. Non-transitory memory 106 further can include drivers, modules, libraries, or engines allowing the livestock warranty aggregation computer 100 to function as a dedicated software/hardware system (i.e. a software service running on a dedicated computer) such as an application server, web server, database server, file server, home server, standalone server. For example, non-transitory memory 106 can include a server-side markup language processor (e.g., a PHP processor) to interpret server-side markup language and generate dynamic web content (e.g., a web page document) to serve to client devices over a communications network.

According to various exemplary embodiments of the present invention, the livestock reimbursement computer 230, in communication with the livestock warranty aggregation computer 100, can allow individual management of risk for a group of different warranty products. The livestock reimbursement computer 230 can be positioned in communication with the livestock warranty aggregation computer 100 by a public or private communications network, such as a LAN or a VPN, defined herein as a reimbursement communications network (not shown). As will be appreciated by those having skill in the art, the reimbursement communications network and the warranty communications network 180 may be part of a single network, and the reimbursement communications network can be described by looking to the description of the warranty communications network 180 herein. In addition, the livestock reimbursement computer 230 may be connected to a producer computer 160 through a public or private network, including the reimbursement communications network or, more particularly, the Internet so that producer computer 160 may interact directly with the livestock reimbursement computer 230. The features of the livestock reimbursement computer 230 described herein allow the livestock reimbursement computer 230 to receive from the livestock warranty aggregation computer 100 one or more warranty products and to send to the livestock warranty aggregation computer payment information responsive to individual casualty data for one or more of the plurality of warranty products.

The livestock reimbursement computer 230, can be, for example, a server and can include, for example, any type of mainframe, physical appliance, or personal computing device such as rack server, mainframe, desktop computer, or the like, dedicated in whole or in part to running one or more services to serve the needs or requests of client programs which may or may not be running on the same computer. The livestock reimbursement computer 230 can be a dedicated software/hardware system (i.e., a software service running on a dedicated computer) such as an application server, web server, database server, file server, or standalone server. As one skilled in the art will appreciate, though the livestock reimbursement computer 230 is shown as a single server, it is possible for the livestock warranty aggregation computer 100 to interface with a separate web or network server to access the functionality of the livestock reimbursement computer 230, for example, through the reimbursement communications network, and such a configuration would be preferred for large-scale implementations.

The livestock reimbursement computer 230 can include, for example, a processor 234. The processor 234 can include, for example, one or more microprocessors, microcontrollers, and other analog and/or digital circuit components configured to perform the functions described herein. The processor 234 is the “brains” of the livestock reimbursement computer 230, and as such executes computer program product or products and works in conjunction with the input/output unit 236 (I/O), for example, to direct data to a non-transitory memory 232 and to send data or commands from the non-transitory memory 232 the communications network 180. The processor 234 can be any commercially available processor, or plurality of processors, adapted for use in or with the livestock reimbursement computer 230. Processor 234 can be, for example, the Intel® Xeon® multicore processors, Intel® micro-architecture Nehalem, and AMD Opteron™ multicore processors. Processor 234 can be operated by an operating system software installed on the non-transitory memory 232, such as Windows Server 2008, Windows Vista, Windows 7, Windows XP, UNIX or UNIX-like family of systems, including BSD and GNU/Linux, and Mac OS X.

Livestock reimbursement computer 230 can further include a non-transitory memory 232 or more than one non-transitory memories. Non-transitory memory 232 can be configured to store data, including computer program product or products, which include instructions for execution on the processor 234. Non-transitory memory 232 can include both non-volatile memory, e.g., hard disks, flash memory, optical disks, and the like, and volatile memory, e.g., SRAM, DRAM, and SDRAM as required to support embodiments of the instant invention. As one skilled in the art will appreciate, though the non-transitory memory 232 is depicted on, e.g., a motherboard, of the livestock reimbursement computer 230, the non-transitory memory 232 also can be a separate component or device, e.g., flash memory, connected to the livestock reimbursement computer 230 through the input/output unit 236. As one skilled in the art will understand, the program product or products, along with one or more databases, data libraries, data tables, data fields, or other data records can be stored either in non-transitory memory 232 or in separate memory (also non-transitory), for example, associated with a storage medium such as database 150, positioned in communication with the livestock reimbursement computer 230 through the I/O 236. Non-transitory memory 232 can further include drivers, modules, libraries, or engines allowing livestock reimbursement computer 230 to function as a dedicated software/hardware system (i.e. a software service running on a dedicated computer) such as an application server, web server, database server, file server, home server, standalone server.

The livestock insurance computer 220 allows collective management of aggregate risk for different warranty products. The livestock insurance computer 220 is positioned in communication with the livestock warranty aggregation computer 100 by a reinsurance communications network (not shown). As will be appreciated by those having skill in the art, the reinsurance communications network and the warranty communications network 180 may be part of a single network, and the reinsurance network can be described by looking to the description of the warranty communications network 180 herein. In addition, the livestock insurance computer 220 may be connected to a producer computer 160 through a public or private network, including the warranty communications network 180 or, more particularly, the Internet so that producer computer 160 may interact directly with the livestock insurance computer 220. The features of the livestock insurance computer 220 described herein allow the livestock insurance computer 220 to receive from the livestock warranty aggregation computer 100 a collective warranty product and to send to the livestock warranty aggregation computer 100 payment information responsive to casualty data for the aggregate risk of different warranty products.

The livestock insurance computer 220 can be, for example, a server and can include, for example, any type of mainframe, physical appliance, or personal computing device such as rack server, mainframe, desktop computer, or the like, dedicated in whole or in part to running one or more services to serve the needs or requests of client programs which may or may not be running on the same computer. The livestock insurance computer 220 can be a dedicated software/hardware system (i.e., a software service running on a dedicated computer) such as an application server, web server, database server, file server, or standalone server. As one skilled in the art will appreciate, though livestock insurance computer 220 is shown as a single server, it is possible for the livestock warranty aggregation computer 100 to interface with a separate web or network server to access the functionality of the livestock insurance computer 220, for example, through the reinsurance communications network, and such a configuration would be preferred for large-scale implementations.

The livestock insurance computer 220 can include, for example, processor 224. Processor 224 can include, for example, one or more microprocessors, microcontrollers, and other analog and/or digital circuit components configured to perform the functions described herein. The processor 224 is the “brains” of the livestock insurance computer 220, and as such executes computer program product or products and works in conjunction with the input/output unit 226 (I/O), for example, to direct data to a non-transitory memory 222 and to send data or commands from the non-transitory memory 222 the reinsurance communications network. The processor 224 can be any commercially available processor, or plurality of processors, adapted for use in or with the livestock insurance computer 220. Processor 224 can be, for example, the Intel® Xeon® multicore processors, Intel® micro-architecture Nehalem, and AMD Opteron™ multicore processors. Processor 224 can be operated by an operating system software installed on the non-transitory memory 222, such as Windows Server 2008, Windows Vista, Windows 7, Windows XP, UNIX or UNIX-like family of systems, including BSD and GNU/Linux, and Mac OS X.

The livestock insurance computer 220 can further include a non-transitory memory 222 or more than one non-transitory memories. Non-transitory memory 222 can be configured to store data, including computer program product or products, which include instructions for execution on the processor 224. Non-transitory memory 222 can include both non-volatile memory, e.g., hard disks, flash memory, optical disks, and the like, and volatile memory, e.g., SRAM, DRAM, and SDRAM as required to support embodiments of the instant invention. As one skilled in the art will appreciate, though the non-transitory memory 222 is depicted on, e.g., a motherboard, of the livestock insurance computer 220, the non-transitory memory 222 may also be a separate component or device, e.g., flash memory, connected to the livestock insurance computer 220 through the input/output unit 226. As one skilled in the art will understand, the program product or products, along with one or more databases, data libraries, data tables, data fields, or other data records can be stored either in non-transitory memory 222 or in separate memory (also non-transitory), for example, associated with a storage medium such as database 150, positioned in communication with the livestock insurance computer 220 through the I/O 226. Non-transitory memory 222 can further include drivers, modules, libraries, or engines allowing livestock insurance computer 220 to function as a dedicated software/hardware system (i.e. a software service running on a dedicated computer) such as an application server, web server, database server, file server, home server, standalone server.

Thus, as is perhaps best illustrated by FIG. 20, an embodiment of the present invention can include a warranty aggregation system. The warranty aggregation system can comprise, for example, a plurality of producer computers 250, each producer computer 160, 170 of the plurality of producer computers 250 being connected to a warranty communications network 180 and having one or more user interface devices 168, 169, 178 to receive from a livestock producer a plurality of customized warranty parameters for a respective herd of a plurality of different herds, each producer computer 160, 170 of the plurality of producer computers further having an input/output unit 166, 176 to output the plurality of customized warranty parameters through the warranty communications network 180 so that a warranty product for the respective herd of the plurality of different herds is generated responsive thereto. The warranty aggregation system can also comprise a warranty rate database 150, having stored therein a warranty rate table 156 and a livestock warranty aggregation computer 100 positioned in communication with the plurality of producer computers 250 through the warranty communications network 180, the livestock warranty aggregation computer 100 being adapted to receive through the warranty communications network 180 the plurality of customized warranty parameters for each herd of the plurality of different herds, the livestock warranty aggregation computer 100 having a processor 102 to generate a warranty product for each herd of the plurality of different herds responsive to the plurality of customized warranty parameters for the respective herd of the plurality of different herds and the warranty rate table 156, thereby defining a plurality of warranty products. The processor 102 can, for example, be further configured to aggregate the plurality of warranty products to thereby define a collective product.

Beneficially, the warranty aggregation system can also include a livestock insurance computer 220 to allow collective management of aggregate risk for the plurality of different warranty products, the livestock insurance computer 220 positioned in communication with the livestock warranty aggregation computer 100 by a reinsurance communications network (not shown), the livestock insurance computer 220 having an input/output unit 226 to receive from the livestock warranty aggregation computer 100 the collective product and to send to the livestock warranty aggregation computer 100 payment information responsive to casualty data for the aggregate risk of the plurality of different warranty products. In addition, and according to exemplary embodiments of the present invention, the livestock warranty aggregation computer 100 can include a livestock reimbursement computer 230 to allow individual management of risk for each of the plurality of different warranty products, the livestock reimbursement computer 230 positioned in communication with the livestock warranty aggregation computer 100 by a reimbursement communications network (not shown), the livestock reimbursement computer 230 having an input/output unit 236 to receive from the livestock warranty aggregation computer 100 one or more of the plurality of warranty products and to send to the livestock warranty aggregation computer 100 payment information responsive to individual casualty data for one or more of the plurality of warranty products.

In addition, the warranty aggregation system can be, for example, adapted to generate a user interface (shown as 600 in FIGS. 3-11) to display at each of the plurality of producer computers 250, the user interface allowing the selection of the customized warranty parameters at the respective user terminal and the transmission of the customized warranty parameters from the respective producer computer 160, 170 to the livestock warranty aggregation computer 100. Moreover, the warranty aggregation system according to various exemplary embodiments of the present invention can also be adapted to distribute payments to a livestock producer account responsive to receiving insurance payments and reimbursement payments for a respective herd.

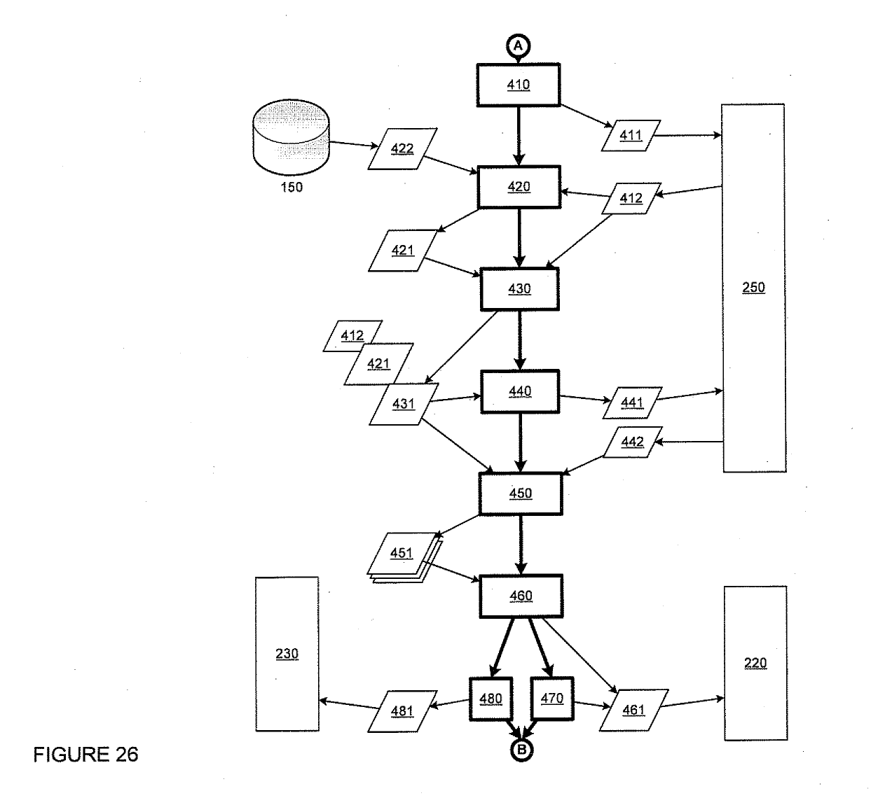

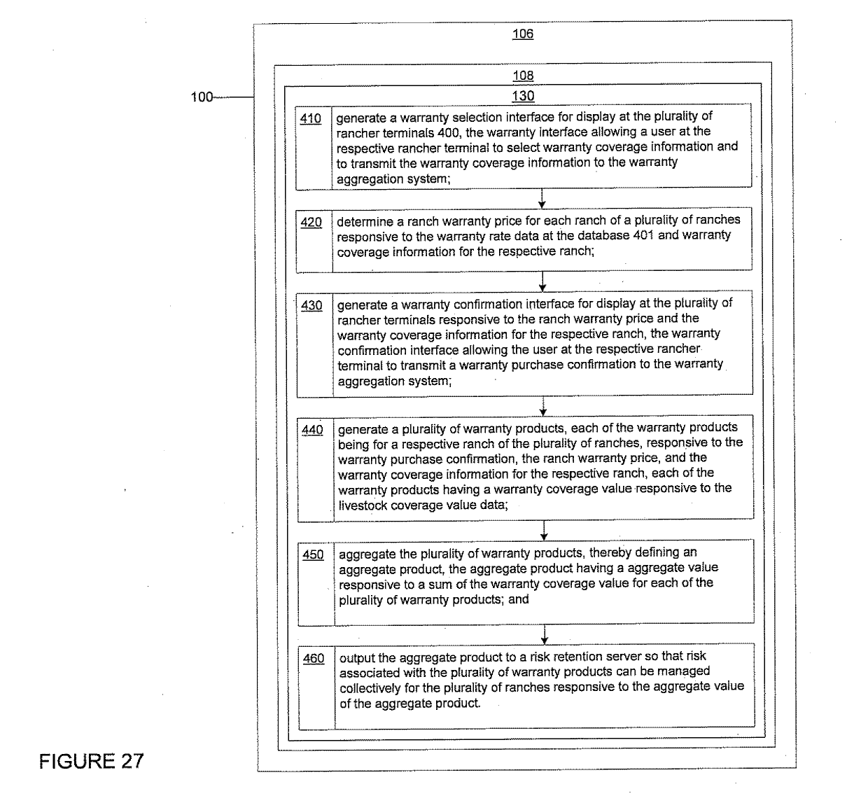

FIGS. 26-27 illustrate yet another exemplary embodiment of the present invention. Particularly, FIGS. 26-27 illustrate a computer readable program product 108 stored in memory 106 of a livestock warranty aggregation computer 100. More particularly, FIG. 26 illustrates the operational and data process flow of the computer readable program product 108. The operational process starts at point A in FIG. 26 and ends at point B in FIG. 26. FIGS. 26-27 thus illustrate that various exemplary embodiments of the present invention can also provide a livestock warranty aggregation computer 100 to aggregate a plurality of customized livestock warranty products so that each of the plurality of customized livestock warranty products is provided to different owners of different herds of a plurality of herds and so that a collective livestock risk product is produced for collective risk management. Beneficially, the livestock warranty aggregation computer 100 can comprise, for example, a processor (not shown), a non-transitory memory 106 positioned in communication with the processor (not shown) to store a computer readable program product 108 therein, and an input/output unit (not shown) connected to the processor (not shown) and the non-transitory memory 106. The input/output unit (not shown), for example can be adapted to be in communication with a plurality of user terminals (labeled herein, producer computers) 250 through a warranty communications network (not shown) to receive one or more warranty parameters from each of the plurality of producer computers 250, each producer computer of the plurality of producer computers 250 corresponding to a different owner of a different herd of the plurality of herds. The livestock warranty aggregation computer 100 can also include, by way of example, a warranty rate database 150 to associate the warranty parameters with a plurality of warranty rates and a computer program product defining a livestock warranty aggregator 140, stored in the non-transitory memory 106 and operable on the processor.

The livestock warranty aggregator 140 can, for example, have a set of instructions that, when executed by the processor (not shown), cause the livestock warranty aggregation computer 100 to perform one or more operations. The one or more operations beneficially can include, for example, the operation of generating 410 a warranty selection interface 411 (and shown as 600 in FIGS. 3-11) to display at the plurality of producer computers 250 the warranty selection interface 411 allowing a livestock producer at a respective producer computer of the plurality of producer computers 250 to select a plurality of customized warranty parameters 412 for a respective herd of the plurality of herds and to transmit from the respective producer computer the plurality of customized warranty parameters 412 to the livestock warranty aggregation computer 100, the plurality of customized warranty parameters 412 including each of a loss type, a livestock type, a quantity of livestock for the livestock type, and a livestock payout value for the livestock type. The one or more operations can also include the operation of determining 420 a herd warranty purchase price 421 for each herd of the plurality of herds responsive to receiving the plurality of customized warranty parameters 412 from the respective producer computer, the herd warranty purchase price 421 being responsive to a respective warranty rate 422 for the livestock type and the plurality of customized warranty parameters 412 for the respective herd, and the operation of generating 430 a warranty proposal 431 for each herd of the plurality of herds responsive to determining the herd warranty purchase price for the respective herd, the warranty proposal 431 including the herd warranty purchase price 421 for the respective herd and the plurality of customized warranty parameters 412 for the respective herd.

Moreover, according to various exemplary embodiments of the present invention, the one or more operations also can include the operation of generating 440 a warranty confirmation interface 441 (shown as 740 in FIGS. 12-15) to display at the plurality of producer computers 250 for each respective herd responsive to the warranty proposal 431 for the respective herd, the warranty confirmation interface 441 allowing the livestock producer at the respective producer computer to confirm the herd warranty purchase price 421 and the customized warranty parameters 412 for the respective herd and to transmit to the livestock warranty aggregation computer 100 a warranty purchase confirmation 442 for the warranty proposal 431 for the respective herd. In addition, the one or more operations can include the operation of generating 450 a warranty product for each herd of the plurality of herds responsive to receiving the warranty purchase confirmation 442 for the respective herd, the warranty product 451 including the herd warranty purchase price 421 for the respective herd and the customized warranty parameters 412 for the respective herd, each warranty product 451 having a warranty payout value corresponding to the livestock payout value for the respective herd, thereby defining a plurality of warranty products 451, each of the plurality of warranty products 451 being different for each respective herd.

Furthermore, according to various embodiments of the present invention, the one or more operations can include the operations of aggregating 460 a collective livestock risk product 461 from the plurality of warranty products 451, the collective livestock risk product 461 having an aggregate liability value responsive to the livestock payout value for each of the plurality of warranty products 451, outputting 470 the collective livestock risk product 461 to a livestock insurance computer 220 to allow enhanced risk management for the plurality of warranty products 451 responsive to the aggregate liability value of the collective livestock risk product 461, and outputting 480 one or more of the plurality of warranty products 451, thereby defining a plurality of claim products 481, to a livestock disease reimbursement computer 230 responsive to receiving casualty data for respective herds of each of the plurality of claim products 481, thereby allowing enhanced compensation for each of the respective different herds.

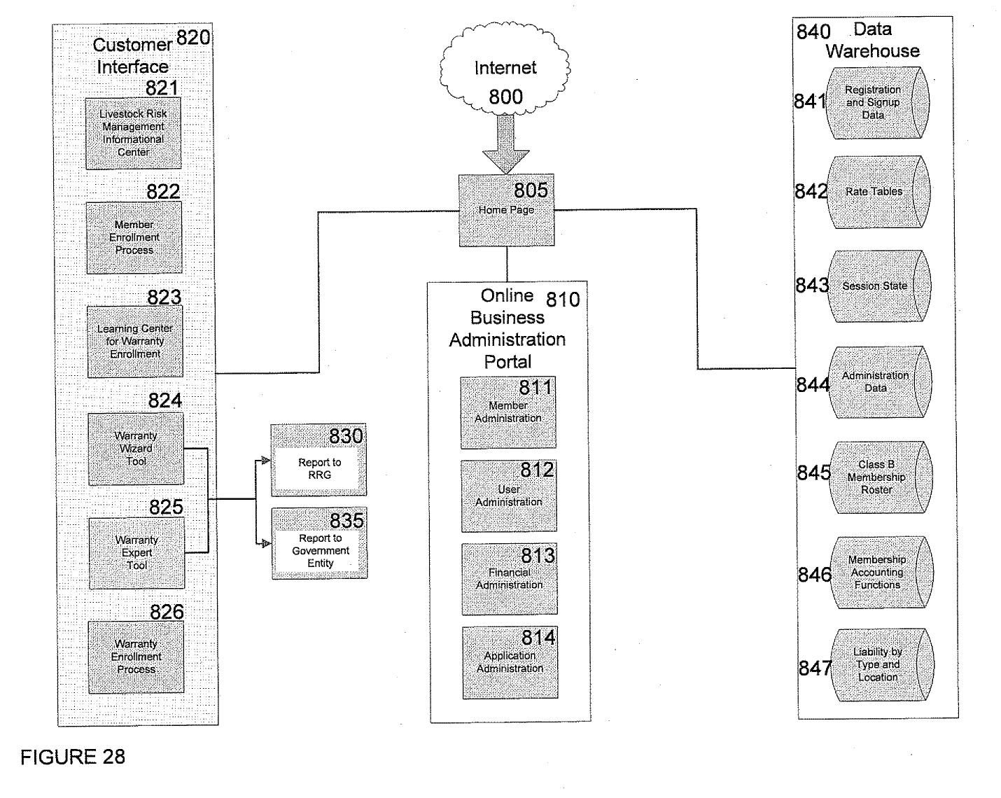

FIG. 28 also is also illustrative of various exemplary embodiments of the present invention. Such exemplary embodiments of the present invention can provide a home page 805 that facilitates selection, confirmation, and purchase of customized warranty products by livestock producers via the Internet 800. The home page can be operably configured to interface with a consumer interface 820, an online business administration portal 810, and a data warehouse 840. The consumer interface 820 can include, for example, a livestock risk management information center module 821, a member enrollment process module 822, a learning center for warranty enrollment module 823, a warranty wizard tool module 824, a warranty expert tool module 825, and a warranty enrollment process module 826. Whereas the consumer interface 820 can be, for example, the face of the system to the livestock purchaser consumer, the online business administration portal 810 can be, for example, the face of the system to one or more warranty issuing entities. The business administration portal 810 can therefore include, for example, a member administration module 811, a user administration module 812, a financial administration module 813, and an application administration module 814. The data warehouse 840 can include, for example, a registration and signup data database 841, a rate table database 842, a session state database 843, an administration data database 844, a class B membership roster database 845, a membership accounting functions database 846, and a liability by type and location database 847. Beneficially, the warranty wizard tool module 824 and the warranty expert tool module 825 can be adapted to interface with at least two reporting modules 830, 835. The report to RRG reporting module 830 can be configured, for example, to generate a livestock management enhancement report, and the Government Entity Reporting module 835 can be configured, for example, to generate a livestock report to a government entity such as, for example, the APHIS.

Advantageously, various embodiments of the present invention can provide one or more individualized warranty products to one or more producers of livestock. Various embodiments of the present invention can also provide one or more individualized warranty products to one or more producers of agricultural crops. With specific respect to beef cattle, various embodiments of the present invention can provide warranty protection to producers against potential financial exposure due to the following specified diseases for beef cattle, as such diseases are known and understood by those skilled in the art: (1) Foot and Mouth Disease; (2) Bovine Spongiform Encephalopathy (BSE); (3) Bovine Tuberculosis; (4) Bovine Brucellosis; and (5) Anthrax. Various embodiments of the present invention also can provide warranty protection for various other diseases if it is determined that such diseases are transmitted as a result of natural, sporadic infection, occasional endemic infection, or acts of terrorism, as is known and understood by those skilled in the art. Under various exemplary embodiments of the present invention, other intentional infections or infection that occurs when a livestock producer fails to conform to certain warranty guidelines, are not provided warranty protection.

Although various embodiments of the present invention have been described mostly in terms of bovine warranty products, the aggregate warranty approach under various embodiments of the present invention is scalable and beneficially can be used to create aggregate warranty products for any kind of animal, crop, or other agricultural product. Warranty coverage provided according to various exemplary embodiments of the present invention can, for example, serve as certification that the enrolled producers comply with specific USDA criteria and marketplace drivers for the specific product or products receiving warranty protection. For underwriting of one or more warranty issuing entities potential warranty related activity, participating producers can be required, for example, to report data to an approved database of their choice. Limited animal production data (i.e. primary premise, source, ID, and age) and animal ID information can be made available to USDA under exemplary embodiments of the present invention but held in one or more private databases. To receive compensation for an indemnified loss by the one or more warranty issuing entities, a producer can be required, for example, to report infected animals within a specified period of discovery and take all reasonable containment and bio-security measures.

It is important to note that while embodiments of the present invention have been described in the context of a fully functional system, those skilled in the art will appreciate that the mechanism of at least portions of the present invention or aspects thereof are capable of being distributed in the form of a computer readable program product stored in a tangible computer medium and a computer readable medium of instructions in a variety of forms for execution on a processor, processors, or the like, and that the present invention applies equally regardless of the particular type of signal bearing media used to actually carry out the distribution. Note, the computer readable program product can be in the form of microcode, programs, routines, and symbolic languages that provide a specific set or sets of ordered operations that control the functioning of the hardware and direct its operation, as known and understood by those skilled in the art. Examples of computer readable media include but are not limited to: nonvolatile hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, HD-DVDs, mini disks, laser disks, Blu-ray disks, and other newer types of memories, and transmission type media such as digital and analog communication links.

Moreover, the foregoing has broadly outlined certain objectives, features, and technical advantages of the present invention and a detailed description of the invention so that embodiments of the invention may be better understood in light of features and advantages of the invention as described herein, which form the subject of certain claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages is better understood from the following description when considered in connection with the accompanying figures. It is to be expressly understood, however, that such description and figures are provided for the purpose of illustration and description only and are not intended as a definition of the limits of the present invention. It will be apparent to those skilled in the art that various modifications and changes can be made within the spirit and scope of the invention as described in the foregoing specification.

That claimed is:

1. A warranty aggregation system to aggregate a plurality of customized livestock warranty products so that each of the plurality of customized livestock warranty products is provided to different owners of different herds of a plurality of herds and so that a collective livestock risk product is produced for collective risk management, the warranty aggregation system comprising:
one or more processors;
non-transitory memory positioned in communication with the one or more processors to store computer program product therein;
an input/output unit connected to the one or more processors and the non-transitory memory, the input/output unit adapted to be in communication with a plurality of remote producer computers through a warranty communications network to receive one or more warranty parameters from each of the plurality of remote producer computers, each remote producer computer of the plurality of producer computers corresponding to a different owner of a different herd of the plurality of herds;
one or more warranty rate databases to associate the warranty parameters with a plurality of warranty rates;
computer program product, defining an aggregator module, stored in the non-transitory memory and operable on the one or more processors, the aggregator module having a set of instructions that, when executed by the one or more processors, cause the warranty aggregation system to perform the following operations:
generating a warranty selection interface to display at one or more of the plurality of remote producer computers, the warranty selection interface allowing a livestock producer at a respective remote producer computer of the plurality of producer computers to select a plurality of customized warranty parameters for a respective herd of the plurality of herds and to transmit from the respective remote producer computer the plurality of customized warranty parameters to the warranty aggregation system, the plurality of customized warranty parameters including each of a loss type, a livestock type, a quantity of livestock for the livestock type, and a livestock payout value for the livestock type,
determining a herd warranty purchase price for each herd of the plurality of herds responsive to receiving the plurality of customized warranty parameters from the respective remote producer computer, the herd warranty purchase price being responsive to a respective warranty rate for the livestock type and the plurality of customized warranty parameters for the respective herd,
generating a warranty proposal for each herd of the plurality of herds responsive to determining the herd warranty purchase price for the respective herd, the warranty proposal including the herd warranty purchase price for the respective herd and the plurality of customized warranty parameters for the respective herd,
generating a warranty confirmation interface to display at one or more of the plurality of remote producer computers for each respective herd responsive to the warranty proposal for the respective herd, the warranty confirmation interface allowing the livestock producer at the respective remote producer computer to confirm the herd warranty purchase price and the customized warranty parameters for the respective herd and to transmit to the warranty aggregation system a warranty purchase confirmation for the warranty proposal for the respective herd,
generating a warranty product for each herd of the plurality of herds responsive to receiving the warranty purchase confirmation for the respective herd, the warranty product including the herd warranty purchase price for the respective herd and the customized warranty parameters for the respective herd, each warranty product having a warranty payout value corresponding to the livestock payout value for the respective herd, thereby defining a plurality of warranty products, each of the plurality of warranty products being different for each respective herd,
aggregating a collective livestock risk product from the plurality of warranty products, the collective livestock risk product having an aggregate liability value responsive to the livestock payout value for each of the plurality of warranty products,
outputting the collective livestock risk product to one or more livestock insurance computers to allow enhanced risk management for the plurality of warranty products responsive to the aggregate liability value of the collective livestock risk product, and
outputting one or more of the plurality of warranty products, thereby defining a plurality of claim products, to one or more livestock reimbursement computers responsive to receiving casualty data for respective herds of each of the plurality of claim products, thereby allowing enhanced compensation for each of the respective different herds.

2. A warranty aggregation system comprising
plurality of producer computers, each producer computer of the plurality of producer computers being connected to a warranty communications network and having a user interface to receive from a user a plurality of customized warranty parameters for a respective herd of a plurality of different herds, each producer computer of the plurality of producer computers further having an input/output unit to output the plurality of customized warranty parameters through the warranty communications network so that a warranty product for the respective herd of the plurality of different herds is generated responsive thereto;
one or more warranty rate databases having stored therein warranty rate data;
one or more livestock warranty aggregation computers positioned in communication with the plurality of producer terminals through the warranty communications network, the one or more livestock warranty aggregation computers being adapted to receive through the warranty communications network the plurality of customized warranty parameters for each herd of the plurality of different herds, the one or more livestock warranty aggregation computer having one or more processors to generate a warranty product for each herd of the plurality of different herds responsive to the plurality of customized warranty parameters for the respective herd of the plurality of different herds and the warranty rate data, thereby defining a plurality of warranty products, the one or more processors further being configured to aggregate the plurality of warranty products to thereby define a collective product;
one or more livestock insurance computers to allow collective management of aggregate risk for the plurality of different warranty products, the one or more livestock insurance computers being positioned in communication with the one or more livestock warranty aggregation computer by a reinsurance communications network, the one or more livestock insurance computers having an input/output unit to receive from the one or more livestock warranty aggregation computer the collective product and to send to the one or more livestock warranty aggregation computers payment information responsive to casualty data for the aggregate risk of the plurality of different warranty products; and
one or more livestock reimbursement computers to allow individual management of risk for each of the plurality of different warranty products, the one or more livestock reimbursement computers being positioned in communication with the one or more livestock warranty aggregation computers by a reimbursement communications network, the one or more livestock reimbursement computers having an input/output unit to receive from the one or more livestock warranty aggregation computers one or more of the plurality of warranty products and to send to the one or more livestock warranty aggregation computers payment information responsive to individual casualty data for one or more of the plurality of warranty products.

3. A warranty aggregation system defined in claim 2, wherein the one or more livestock warranty aggregation computers is adapted to generate a user interface to display at each of the plurality of producer computers, the user interface allowing the selection of the customized warranty parameters at the respective producer computer and the transmission of the customized warranty parameters from the respective producer computer to livestock warranty aggregation computer.

4. A warranty aggregation system defined in claim 3, wherein the one or more livestock warranty aggregation computers is configured to distribute payments to one or more livestock producer accounts responsive to receiving one or more of insurance payments and reimbursement payments for a respective herd.

5. Non-transitory computer storage medium having computer program stored therein including a set of instructions that when executed by one or more processors cause the one or more processors to perform the operations of:
generating a warranty selection interface to display at the plurality of producer computers, the warranty selection interface allowing a livestock producer at a respective producer computer of the plurality of producer computers to select a plurality of customized warranty parameters for a respective herd of the plurality of herds and to transmit from the respective producer computer the plurality of customized warranty parameters to the warranty aggregation system;
determining a herd warranty purchase price for each herd of the plurality of herds responsive to receiving the plurality of customized warranty parameters from the respective producer computer, the herd warranty purchase price being responsive to a respective warranty rate for the livestock type and the plurality of customized warranty parameters for the respective herd;
generating a warranty proposal for each herd of the plurality of herds responsive to determining the herd warranty purchase price for the respective herd, the warranty proposal including the herd warranty purchase price for the respective herd and the plurality of customized warranty parameters for the respective herd;
generating a warranty confirmation interface to display at the plurality of producer computers for each respective herd responsive to the warranty proposal for the respective herd, the warranty confirmation interface allowing the livestock producer at the respective producer computer to confirm the herd warranty purchase price and the customized warranty parameters for the respective herd and to transmit to the warranty aggregation system a warranty purchase confirmation for the warranty proposal for the respective herd;
generating a warranty product for each herd of the plurality of herds responsive to receiving the warranty purchase confirmation for the respective herd, the warranty product including the herd warranty purchase price for the respective herd and the customized warranty parameters for the respective herd, each warranty product having a warranty payout value corresponding to the livestock payout value for the respective herd, thereby defining a plurality of warranty products, each of the plurality of warranty products being different for each respective herd;
aggregating a collective livestock risk product from the plurality of warranty products, the collective livestock risk product having an aggregate liability value responsive to the livestock payout value for each of the plurality of warranty products;
outputting the collective livestock risk product to a livestock insurance computer to allow enhanced risk management for the plurality of warranty products responsive to the aggregate liability value of the collective livestock risk product; and
outputting one or more of the plurality of warranty products, thereby defining a plurality of claim products, to a livestock reimbursement computer responsive to receiving casualty data for respective herds of each of the plurality of claim products, thereby allowing enhanced compensation for each of the respective different herds.

6. Non-transitory computer storage medium as defined in claim 5, wherein the plurality of customized warranty parameters including each of a loss type, a livestock type, a quantity of livestock for the livestock type, and a livestock payout value for the livestock type.

7. A computer implemented method to aggregate a plurality of customized livestock warranty products so that each of the plurality of customized livestock warranty products is provided to different owners of different herds of a plurality of herds and so that a collective livestock risk product is produced for collective risk management, the computer implemented method comprising the steps of:
generating a warranty selection interface to display at the plurality of producer computers, the warranty selection interface allowing a livestock producer at a respective producer computer of the plurality of producer computers to select a plurality of customized warranty parameters for a respective herd of the plurality of herds and to transmit from the respective producer computer the plurality of customized warranty parameters to the warranty aggregation system;
determining a herd warranty purchase price for each herd of the plurality of herds responsive to receiving the plurality of customized warranty parameters from the respective producer computer, the herd warranty purchase price being responsive to a respective warranty rate for the livestock type and the plurality of customized warranty parameters for the respective herd;
generating a warranty proposal for each herd of the plurality of herds responsive to determining a herd warranty purchase price for the respective herd, the warranty proposal including the herd warranty purchase price for the respective herd and the plurality of customized warranty parameters for the respective herd;
generating a warranty confirmation interface to display at the plurality of producer computers for each respective herd responsive to the warranty proposal for the respective herd, the warranty confirmation interface allowing the livestock producer at the respective producer computer to confirm the herd warranty purchase price and the customized warranty parameters for the respective herd and to transmit to the warranty aggregation system a warranty purchase confirmation for the warranty proposal for the respective herd;
generating a warranty product for each herd of the plurality of herds responsive to receiving the warranty purchase confirmation for the respective herd, the warranty product including the herd warranty purchase price for the respective herd and the customized warranty parameters for the respective herd, each warranty product having a warranty payout value corresponding to a livestock payout value for the respective herd, thereby defining a plurality of warranty products, each of the plurality of warranty products being different for each respective herd;
aggregating a collective livestock risk product from the plurality of warranty products, the collective livestock risk product having an aggregate liability value responsive to the livestock payout value for each of the plurality of warranty products;
outputting the collective livestock risk product to one or more livestock insurance computers to allow enhanced risk management for the plurality of warranty products responsive to the aggregate liability value of the collective livestock risk product; and
outputting one or more of the plurality of warranty products, thereby defining a plurality of claim products, to one or more livestock reimbursement computers responsive to receiving casualty data for respective herds of each of the plurality of claim products, thereby allowing enhanced compensation for each of the respective different herds.

8. A computer-implemented method as defined in claim 7, wherein the plurality of customized warranty parameters include each of a loss type, a livestock type, a quantity of livestock for the livestock type, and a livestock payout value for the livestock type.
